(19) United States
(12) Patent Application Publication
(10) Pub. No.: US 2014/0362002 A1
(43) Pub. Date: Dec. 11, 2014

(54) DISPLAY CONTROL DEVICE, DISPLAY CONTROL METHOD, AND COMPUTER PROGRAM PRODUCT

(71) Applicant: KABUSHIKI KAISHA TOSHIBA, Tokyo (JP)

(72) Inventors: Toshiaki NAKASU, Tokyo (JP); Kazunori IMOTO, Kawasaki-shi (JP); Yasunobu YAMAUCHI, Yokohama-shi (JP)

(73) Assignee: KABUSHIKI KAISHA TOSHIBA, Tokyo (JP)

(21) Appl. No.: 14/198,202

(22) Filed: Mar. 5, 2014

(30) Foreign Application Priority Data
Jun. 11, 2013 (JP) 2013-122413

(51) Int. Cl. G06F 3/041

(52) U.S. Cl. CPC G06F 3/041
USPC 345/173

(57) ABSTRACT

According to an embodiment, a display control device includes a first acquisition unit, a second acquisition unit, a first calculator, a second calculator, a control unit. The first acquisition unit is configured to acquire first position information representing a contact position of an input device on a screen. The second acquisition unit is configured to acquire second position information representing a contact position of an object holding the input device on the screen. The first calculator is configured to calculate a first vector having the contact positions of the object and the input device as start and end points, respectively, based on the first and second position information. The second calculator is configured to calculate a second vector representing a display direction based on an angle formed by a reference vector and the first vector. The control unit is configured to control display in accordance with the second vector.

### CROSS-REFERENCE TO RELATED APPLICATION

This application is based upon and claims the benefit of priority from Japanese Patent Application No. 2013-122413, filed on Jun. 11, 2013; the entire contents of which are incorporated herein by reference.

### FIELD

Embodiments described herein relate generally to a display control device, a display control method, and a computer program product.

### BACKGROUND

Hitherto, a device displaying an operation menu near a touched position at a time when the screen is touched using a pen-type input device (when a pen tip is brought into contact with the screen) has been known. In recent years, in using such a device, information is frequently read in a plurality of directions such as upward, downward, leftward, and rightward directions, and the screen is frequently operated in such a plurality of directions.

However, in conventional devices, in the case of a display form having a specified reading direction, the reading direction cannot be changed in accordance with a direction in which a user sees the screen.

### BRIEF DESCRIPTION OF THE DRAWINGS

FIGS. 1A and 1B are diagrams that illustrate examples of the appearance of a display control device according to a first embodiment;

FIG. 2 illustrates an example of the use of the display control device according to the first embodiment;

FIG. 3 is a diagram that illustrates an example of the functional configuration of the display control device according to the first embodiment;

FIG. 4 illustrates an example of the acquisition of position information according to the first embodiment;

FIG. 5 is a diagram that illustrates an example of a first vector according to the first embodiment;

FIGS. 6A and 6B are diagrams that illustrate an example of vectors representing user's directions according to the first embodiment;

FIG. 7 is a flowchart that illustrates an example of the process sequence at the time of performing display control according to the first embodiment;

FIGS. 8A and 8B are diagrams that illustrate examples of the operation performed at the time of performing display control according to the first embodiment;

FIGS. 9A and 9B are diagrams that illustrate examples of the operation performed at the time of performing display control according to Modification 1;

FIGS. 10A and 10B are diagrams that illustrate characteristics of ways of holding a pen according to Modification 2;

FIG. 11 is a diagram that illustrates an example of the functional configuration of a display control device according to a second embodiment;

FIGS. 12A and 12B are diagrams that illustrate examples of data of control information according to the second embodiment;

FIG. 13 is a flowchart that illustrates an example of the process sequence at the time of performing display control according to the second embodiment;

FIG. 14 is a diagram that illustrates an example of data of control information according to Modification 3;

FIGS. 15A and 15B are diagrams that illustrate examples of the control of the screen according to Modification 4;

FIG. 16 illustrates an application example of an estimation method according to an embodiment;

FIGS. 17A and 17B are diagrams that illustrate an example (1) of the use of the display control device according to an embodiment;

FIGS. 18A and 18B are diagrams that illustrate another example (2) of the use of the display control device according to an embodiment;

FIG. 19 is a diagram that illustrates an example of candidate vectors in a case where the screen is surrounded to be used by four users;

FIGS. 20A and 20B are diagrams that illustrate examples of candidate vectors in a case where two users use the screen being interposed therebetween;

FIGS. 21A and 21B are diagrams that illustrate examples of data of control information according to an embodiment;

FIG. 22 is a diagram that illustrates an example of the use of a plurality of display control devices according to an embodiment;

FIG. 23 is a diagram that illustrates an example of candidate vectors in a case where the extended screen is surrounded to be used by four users; and

FIG. 24 is a diagram that illustrates an example of the configuration of a display control device according to an embodiment.

### DETAILED DESCRIPTION

According to an embodiment, a display control device includes a first acquisition unit, a second acquisition unit, a first calculator, a second calculator, and a controller. The first acquisition unit is configured to acquire first position information representing a first contact position on a screen with an input device. The second acquisition unit is configured to acquire second position information representing a second contact position on the screen with an object holding the input device. The first calculator is configured to calculate a first vector having the second contact position as a start point and having the first contact position as an end point based on the first position information and the second position information. The second calculator is configured to calculate a second vector representing a display direction based on an angle formed by a reference vector representing a first direction of the screen and the first vector. The controller is configured to control the display in accordance with the second vector.

Hereinafter, display control devices, display control methods, and display control programs according to embodiments will be described in detail with reference to the accompanying drawings.

### First Embodiment

### Overview

The function (hereinafter, referred to as a “display control function”) of a display control device according to this embodiment will now be described. The display control device according to this embodiment acquires first position information that represents a contact position on a screen that is in contact with an input device. In addition, the display control device according to this embodiment acquires second position information that represents a contact position on the screen that is in contact with an object holding the input device. The display control device according to this embodiment calculates a first vector having the contact position of the object holding the input device as a start point and the contact position of the input device as an end point based on the first and second position information. The display control device according to this embodiment estimates a user's direction with respect to the screen based on an angle formed by a reference vector representing a predetermined direction of the screen and the first vector. Based on the result of the estimation, a second vector representing the display direction is calculated. The display control device according to this embodiment rotates a control target image in accordance with the second vector and controls the display. The display control device according to this embodiment has such a function.

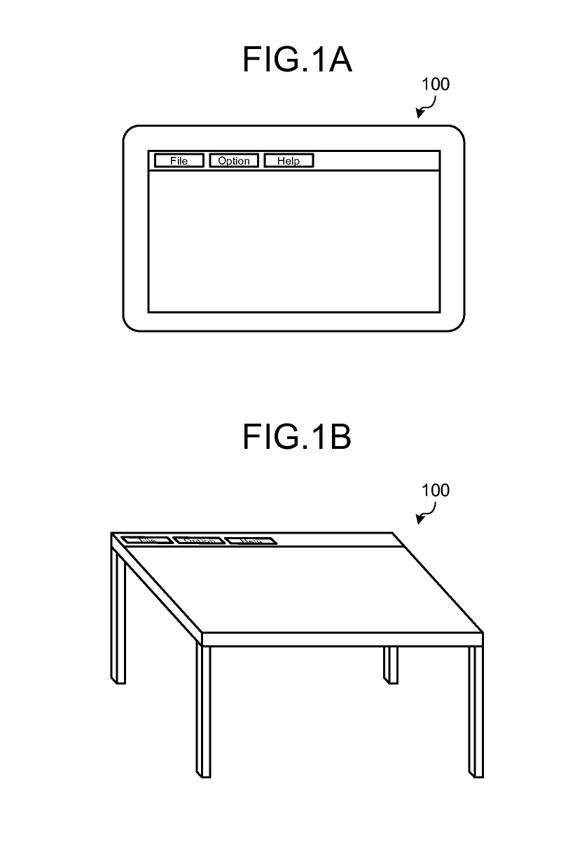

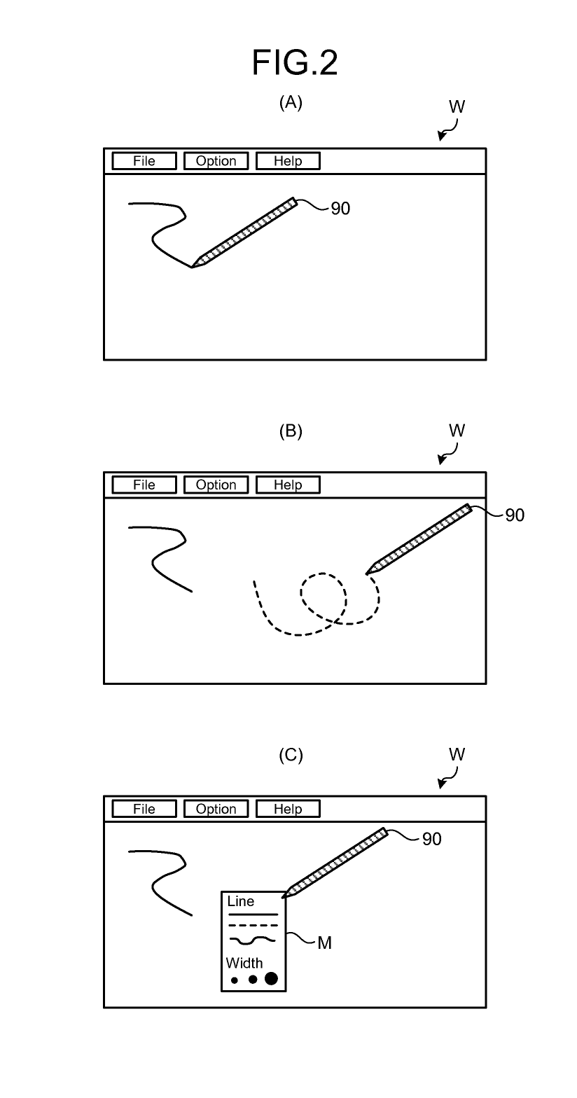

FIGS. 1A and 1B are diagrams that illustrate examples of the appearance of a display control device 100 according to this embodiment. As illustrated in FIGS. 1A and 1B, as the types of the display control device 100 according to this embodiment, there are a tablet type, a table type, and the like. FIG. 2 illustrates an example of the use of the display control device 100 according to this embodiment. In FIG. 2, an example of the use in a case where a line is input is illustrated. A user touches a screen W, for example, using a pen-type input device 90 and operates the screen W so as to draw a line using an ordinary pen. As a result, as illustrated in (A) of FIG. 2, an operation trajectory (a movement trajectory on the screen W) of the input device 90 is displayed on the screen W. At this time, as illustrated in (B) of FIG. 2, in a case where the line type of a line to be input is desired to be changed, for example, the user touches an arbitrary position on the screen W for a predetermined time using the input device 90 (long press). As a result, as illustrated in (C) of FIG. 2, an operation menu M enabling a selection of the line type is displayed near the touch position (contact position) of the input device 90 on the screen W. Generally, for images such as the operation menu M that are displayed in this way, the reading direction is frequently specified in accordance with the writing direction of characters and the like.

However, in a conventional device, in a case where the operation menu M for which the reading direction is specified as described above is displayed, the direction of a display image cannot be changed to be an appropriate reading direction in accordance with a user's direction with respect to the screen W. In other words, in a conventional device, in the case of a display form having a specified reading direction, the reading direction cannot be changed in accordance with the user's reading direction for the screen W.

In consideration of features of the use of devices in recent years that information is read in a plurality of directions, and the screen is operated in a plurality of directions, also from the viewpoint of improving the convenience, it is preferable that the display be controlled for an appropriate reading direction in accordance with the user's direction for the screen W. More specifically, it is preferable to perform the following control process. For example, in a case where the user moves from the lower side of the screen W to the right side thereof on a rectangular screen W, the image of the operation menu M is displayed by being rotated counterclockwise by 90°.

Then, the display control device 100 according to this embodiment acquires a contact position of the input device 90 on the screen W and a contact position of an object holding the input device 90. The display control device 100 according to this embodiment calculates a vector having these two contact positions as a start point and an end point and estimates the user's direction with respect to the screen W based on the angle formed by the reference vector representing a predetermined direction of the screen W and the calculated vector. The display control device 100 according to this embodiment rotates a control target image in accordance with the user's direction that has been estimated, and controls the display. In other words, the display control device 100 according to this embodiment employs a structure in which the user's direction with respect to the screen W is estimated based on two units of position information of the input device 90 and the object holding the input device 90, and the image is rotated and displayed in accordance with the user's direction that has been estimated.

As a result, the display control device 100 according to this embodiment can change the direction of the display image to be an appropriate reading direction in accordance with the user's direction with respect to the screen W. From this, on the use situations of reading information and operating screen in a plurality of directions, even in the case of a display form having a specified reading direction, the display control device 100 according to this embodiment can display the screen in a reading direction that is appropriate for the user. Accordingly, the display control device 100 according to this embodiment can provide reading and operating environments having a high degree of convenience.

Hereinafter, the configuration and the operation of the display control function according to this embodiment will be described.

Functional Configuration

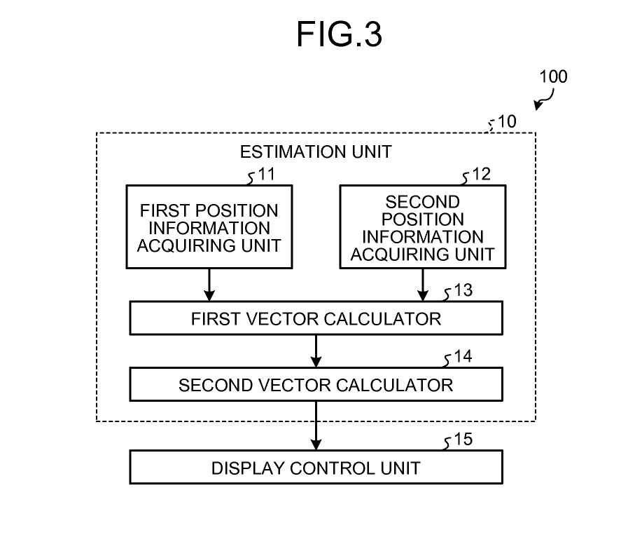

FIG. 3 is a diagram that illustrates an example of the functional configuration of the display control device 100 according to this embodiment. As illustrated in FIG. 3, the display control device 100 according to this embodiment includes a first position information acquiring unit 11, a second position information acquiring unit 12, a first vector calculator 13, a second vector calculator 14, a display control unit 15, and the like.

The first position information acquiring unit (first acquisition unit) 11 according to this embodiment acquires first position information that represents a contact position on the screen that is in contact with the input device 90. The second position information acquiring unit 12 according to this embodiment acquires second position information that represents a contact position on the screen that is in contact with the object holding the input device 90.

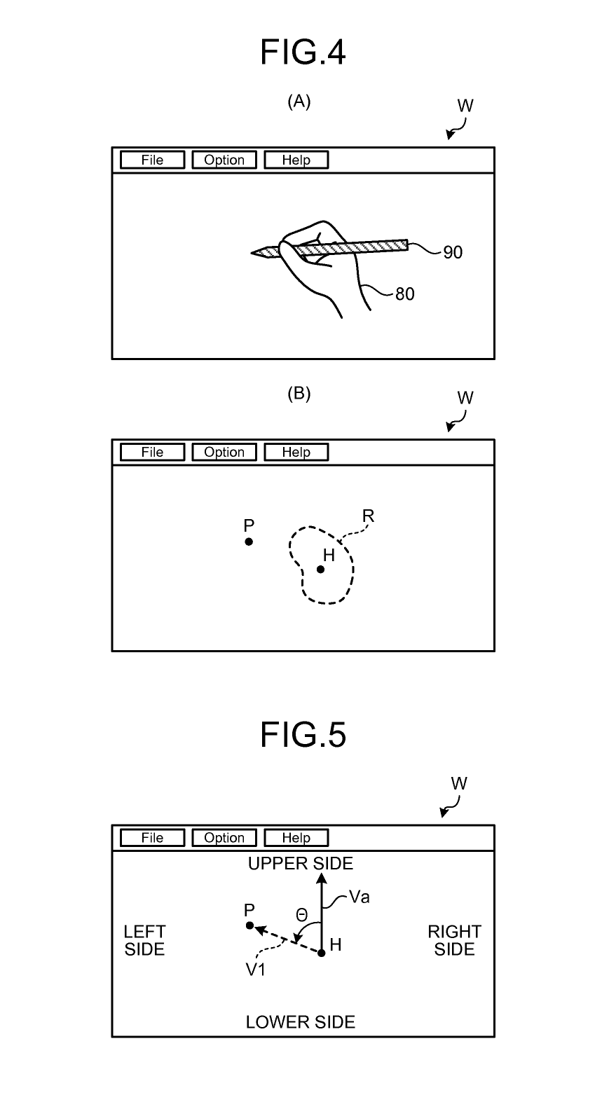

FIG. 4 illustrates an example of the acquisition of position information according to this embodiment. As illustrated in (A) of FIG. 4, for example, a user uses the input device 90 similarly to a writing tool such as a pen. When such a use situation is considered, the first position information acquiring unit 11 and the second position information acquiring unit 12 acquire position information as illustrated in (B) of FIG. 4. In the subsequent description, the above-described use situation is considered, and for the convenience of description, the input device 90 will be referred to as a “pen 90”, and the object holding the input device 90 will be referred to as a “hand 80”.

The first position information acquiring unit 11 acquires the coordinate value of a contact position P of the pen 90 on the screen W as the first position information. Accordingly, the first position information corresponds to the position information (hereinafter, referred to as “pen position information”) of the pen 90, and the first position information acquiring unit 11 corresponds to a pen position information acquiring unit.

The second position information acquiring unit (second acquisition unit) 12 acquires a touch area (contact area) R of the hand 80 holding the pen 90 on the screen W. In other words, the second position information acquiring unit 12 detects the area (object area) of the hand 80 holding the pen 90 from the entire area of the screen W. Next, the second position information acquiring unit 12 acquires a coordinate value of the center (contact position) H of the acquired touch area R as the second position information. Accordingly, the second position information corresponds to the position information (hereinafter, referred to as “hand position information”) of the hand 80, and the second position information acquiring unit 12 corresponds to a hand position information acquiring unit. The method of acquiring the area of the hand 80 holding the pen 90 is not limited to the method of detecting the touch area R. For example, a method or the like may be used in which a captured image acquired by capturing the screen W from the upper side or the lower side is analyzed, and the area of the hand 80 is detected based on a result of the analysis.

The description will be returned to FIG. 3. The first vector calculator (first calculator) 13 according to this embodiment calculates a first vector based on the first position information (pen position information) and the second position information (hand position information).

FIG. 5 is a diagram that illustrates an example of the first vector V1 according to this embodiment. As illustrated in FIG. 5, the first vector calculator 13 calculates the first vector V1 having the contact position H of the hand 80, which is based on the second position information, as a start point and the contract position P of the pen 90, which is based on the first position information, as an end point. In addition, the first vector calculator 13 acquires an angle Θ formed by a reference vector Va representing a predetermined direction of the screen W and the first vector V1. In FIG. 5, an example of the reference vector Va that represents an upward direction of the screen W is illustrated. In this case, in this embodiment, an angle Θ formed by the counterclockwise rotation of the reference vector Va and the first vector V1 is acquired.

The description will be returned to FIG. 3. The second vector calculator (second calculator) 14 according to this embodiment estimates the user's direction with respect to the screen W based on the angle Θ formed by the reference vector Va and the first vector V1 and calculates a second vector that represents the display direction of a control target image based on the result of the estimation.

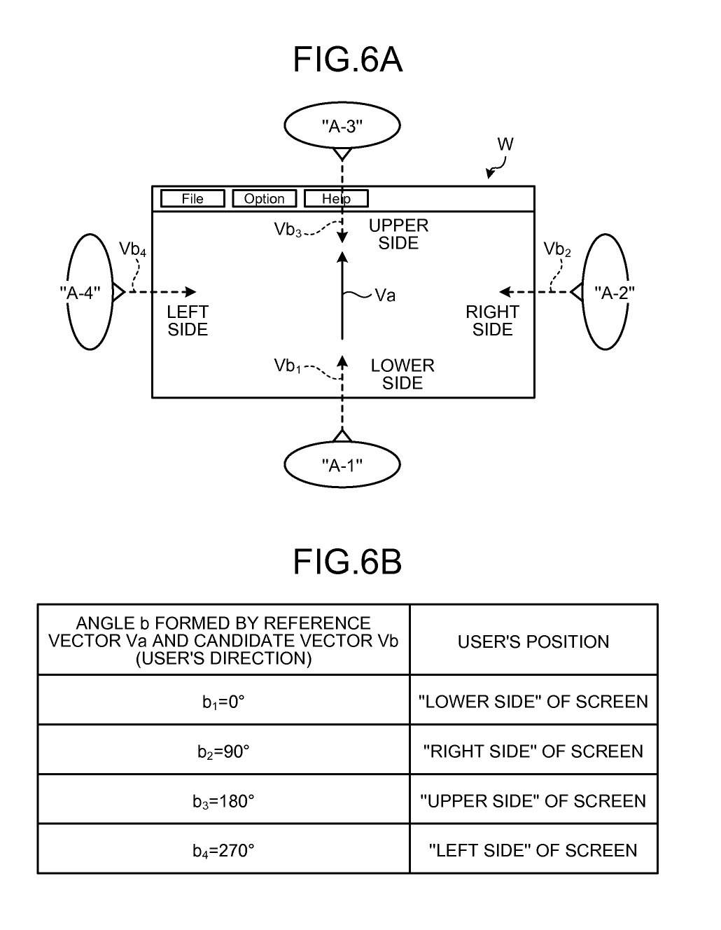

FIGS. 6A and 6B are diagrams that illustrate an example of vectors Vb₁ to Vb₄ representing user's directions according to the first embodiment. FIGS. 6A and 6B illustrate an example of four vectors (hereinafter, for the convenience of description, referred to as “candidate vectors”) Vb₁ to Vb₄ (hereinafter, referred to as a “plurality of candidate vectors Vb” in the case of being collectively referred to) representing user's directions considered for a rectangular screen W. FIG. 6A illustrates a candidate vector Vb₁ representing the upward direction on the screen W, a candidate vector Vb₂ representing the leftward direction, a candidate vector Vb₃ representing the downward direction, and a candidate vector Vb₄ representing the rightward direction. FIG. 6B illustrates the correspondence relation between four angles b₁ to b₄ {=0°, 90°, 180°, and 270°} formed by the reference vector Va and the candidate vectors Vb₁ to Vb₄ and the user's position with respect to the screen W.

For example, in a case where the user is positioned to the “lower side” of the screen as “A-1”, the direction (user's direction) in which the user watches the screen W is the upward direction. Accordingly, the candidate vector Vb₁ having the angle b₁ formed together with the reference vector Va to be the upward direction of 0° represents the direction of the user direction positioned to the “lower side” of the screen and corresponds to an appropriate display direction for the user. In a case where the user is positioned to the “right side” of the screen as “A-2”, the direction in which the user watches the screen W is the leftward direction. Accordingly, the candidate vector Vb₂ having the angle b₂ formed counterclockwise together with the reference vector Va to be the leftward direction of 90° represents the direction of the user positioned to the “right side” of the screen and corresponds to an appropriate display direction for the user. In a case where the user is positioned to the “upper side” of the screen as “A-3”, the direction in which the user watches the screen W is the downward direction. Accordingly, the candidate vector Vb₃ having the angle b₃ formed counterclockwise together with the reference vector Va to be the downward direction of 180° represents the direction of the user positioned to the “upper side” of the screen and corresponds to an appropriate display direction for the user. In a case where the user is positioned to the “left side” of the screen as “A-4”, the direction in which the user watches the screen W is the rightward direction. Accordingly, the candidate vector Vb₄ having the angle b₄ formed counterclockwise together with the reference vector Va to be the rightward direction of 270° represents the direction of the user positioned to the “left side” of the screen and corresponds to an appropriate display direction for the user. In this way, the four candidate vectors Vb₁ to Vb₄ correspond to candidates for the display direction for the user on the rectangular screen W. Accordingly, the angles b₁ to b₄ formed by the reference vector Va and each of the four candidate vectors Vb₁ to Vb₄ correspond to four angles b₁ to b₄ representing the upward, downward, leftward, and the rightward directions (a plurality of directions) corresponding to the candidates for the display direction.

The description will be returned to FIG. 3. The second vector calculator 14 according to this embodiment estimates the user's direction with respect to the screen W based on the angle Θ formed by the reference vector Va and the first vector V1. Next, the second vector calculator 14 selects one vector representing the display direction for the estimated user's direction from among the plurality of candidate vectors Vb (candidates for selection). From this, the second vector calculator 14 calculates a second vector V2 that represents the display direction according to the user's direction.

More specifically, the second vector calculator 14 calculates the second vector V2 representing the display direction by using the following method. The second vector calculator 14, first, calculates an angle a (first angle) by using Equation (1).

a=Θ+α−β (1)

Θ represented in the equation corresponds to an angle formed by the reference vector Va and the first vector V1. In a case where the value is negative, n×360° (here, n is an integer) is added thereto so as to be corrected to be in the range of 0°≦a<360°. In addition, a represented in the equation corresponds to a first adjustment amount (first adjustment angle) that is based on the way of holding the pen 90 with the hand 80 (dominant hand). In this embodiment, a case is assumed in which the user's dominant hand is the right hand, and the user has no habit regarding the way of holding the pen 90. Thus, in this embodiment, the first adjustment amount α is set to 0°. In addition, β represented in the equation corresponds to a second adjustment amount (second adjustment angle) according to the display direction to which the screen W can respond. In this embodiment, it is assumed that information reading and a screen operation are performed for the screen W in four directions of the upward, downward, leftward, and rightward directions. In such a case, generally, the pen 90 is frequently held at an angle of 45° counterclockwise with reference to a vector directed to be perpendicular to sides that are positioned on the upper, lower, left, and right sides of the rectangular screen W. Thus, in this embodiment, the second adjustment amount β is set to 45°.

From this, in this embodiment, Equation 1 becomes Equation (1-1).

a=Θ−45° (1-1)

In a case where the user's dominant hand is the right hand, the second vector calculator 14 calculates Equation 1-1, thereby acquiring the angle a. From among the angles b₁ to b₄ {Θ=0°, 90°, 180°, and 270°} (hereinafter referred to as a “formed angle b” in the case of being collectively referred to) formed by the reference vector Va and each of the four candidate vectors Vb₁ to Vb₄, the second vector calculator 14 specifies the angle b that is approximated most by the angle a that is acquired as a result of the calculation. In other words, the second vector calculator 14, from among the four angles b₁ to b₄ (hereinafter, referred to as the “angle b” in the case of being collectively referred to) representing the directions of the candidate vectors Vb₁ to Vb₄, specifies the angle b that is approximated most by the angle a acquired as a result of the calculation.

At this time, the second vector calculator 14 calculates difference values c₁ to c₄ between the angle a (first angle) and the angles b₁ to b₄ (second angles) by using Equations (2-1) to (2-4).

c₁=|a−b₁| (2-1)

c₂=|a−b₂| (2-2)

c₃=|a−b₃| (2-3)

c₄=|a−b₄| (2-4)

Next, the second vector calculator 14 compares the difference values c₁ to c₄ (hereinafter, referred to as a “difference value c” in the case of being collectively referred to) acquired as a result of calculations with each other and specifies the angle b for which the calculation result of the difference value c is the smallest based on the result of the comparison as the angle b that is approximated by the angle a. From this, the second vector calculator 14 estimates the user's direction of a case where the upward direction of the screen W is set as the reference based on the specified angle b.

In accordance with this, the second vector calculator 14 selects one vector representing the display direction for the estimated user's direction based on the specified angle b from among a plurality of candidate vectors Vb. The second vector calculator 14 acquires the selected vector as a result of the calculation of the second vector V2. In this way, the second vector calculator 14 determines an appropriate display direction for the estimated user's direction from among a plurality of directions corresponding to candidates for the display direction and sets the determined direction as the direction of the second vector V2.

In this manner, in this embodiment, the first position information acquiring unit 11, the second position information acquiring unit 12, the first vector calculator 13, and the second vector calculator 14 correspond to an estimation unit 10 that estimates the user's direction with respect to the screen W.

The display control unit (control unit) 15 according to this embodiment rotates and displays the control target image in accordance with the second vector V2 and controls the display. At this time, the display control unit 15 performs rotation control of the image of the operation menu M corresponding to the control target image as below.

For example, in a case where the candidate vector Vb₂ in the direction of the angle b₂ formed together with the reference vector Va is acquired (selected) as a result of the calculation of the second vector V2, the image of the operation menu M is rotated counterclockwise by 90° and displayed in accordance with the angle b₂. In a case where the candidate vector Vb₃ in the direction of the angle b₃ formed together with the reference vector Va is acquired as a result of the calculation of the second vector V2, the image of the operation menu M is rotated counterclockwise by 180° and displayed in accordance with the angle b₃. In addition, in a case where the candidate vector Vb₄ in the direction of the angle b₄ formed together with the reference vector Va is acquired as a result of the calculation of the second vector V2, the image of the operation menu M is rotated counterclockwise by 270° and displayed in accordance with the angle b₄. In a case where the candidate vector Vb₁ in the direction of the angle b₁ formed together with the reference vector Va is acquired as a result of the calculation of the second vector V2, the image of the operation menu M is displayed without being rotated in accordance with the angle b₁.

The display control unit 15 displays the image of the operation menu M, which has been rotated in this way, near the contact position P of the pen 90 based on the first position information (pen position information). As a method of displaying the image near the contact position, for example, there is a method in which, in a case where the hand 80 holding the pen 90 is the right hand (the user's dominant hand is the right hand), display is performed such that the coordinate value of the upper right end point of the image after rotation coincides with the coordinate value of the contact position P of the pen 90. In other words, the display control unit 15 displays the image of the operation menu M at a position that is not hidden by the pen 90, the hand 80, and the like. The method of controlling the display is not limited to the method of rotating and displaying the control target image. For example, a method may be used in which one image is selected from among a plurality of rotated images (display candidates), and the selected image is displayed. More specifically, from among four rotated images that are acquired by rotating the image of the operation menu M by 0°, 90°, 180°, and 270°, a corresponding image is selected and displayed in accordance with the angle b.

Details

Hereinafter, a detailed operation (associated operations of the functional units) of the display control device 100 according to this embodiment will be described with reference to a flowchart.

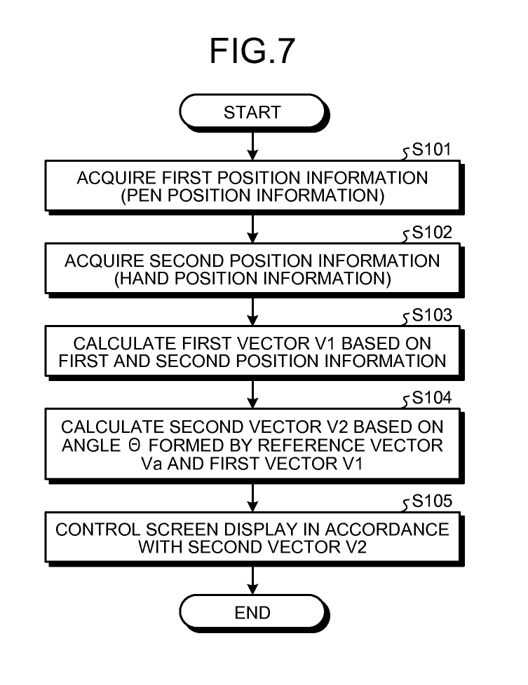

FIG. 7 is a flowchart that illustrates an example of the process sequence at the time of performing display control according to this embodiment. As illustrated in FIG. 7, in the display control device 100 according to this embodiment, first, the first position information acquiring unit 11 acquires the first position information (pen position information) based on the contact position P of the pen 90 in Step S101. Next, in the display control device 100, the second position information acquiring unit 12 acquires the second position information (hand position information) based on the contact position H of the hand 80 holding the pen 90 in Step S102.

In accordance with this, in the display control device 100, the first vector calculator 13 calculates the first vector V1 based on the first position information (pen position information) and the second position information (hand position information) that have been acquired in Step S103. At this time, the first vector calculator 13 calculates the first vector V1 having the contact position H of the hand 80, which is based on the second position information, as a start point and has the contact position P of the pen 90, which is based on the first position information, as an end point and acquires an angle Θ formed by the reference vector Va representing the upward direction of the screen W and the first vector V1.

Next, in the display control device 100, the second vector calculator 14 calculates the second vector V2 representing the display direction of the control target image based on the acquired angle Θ in Step S104. At this time, the second vector calculator 14 estimates the user's direction of a case where the upward direction of the screen W is used as the reference based on the angle Θ formed by the reference vector Va and the first vector V1. As a result, the second vector calculator 14 selects one vector representing the display direction for the estimated user's direction from among a plurality of candidate vectors Vb. From this, the second vector calculator 14 sets the selected vector as the second vector V2, thereby calculating the second vector V2 that represents the display direction according to the user's direction.

In accordance with this, in the display control device 100, the display control unit 15 controls the display in accordance with the calculated second vector V2 in Step S105. At this time, the display control unit 15 performs control of the rotation of the image in the coordinate space of the screen W such that the display direction of the image of the operation menu M corresponding to the control target image is the direction of the second vector V2.

Hereinafter, examples of the display control operation will be described using an example of specific numerical values.

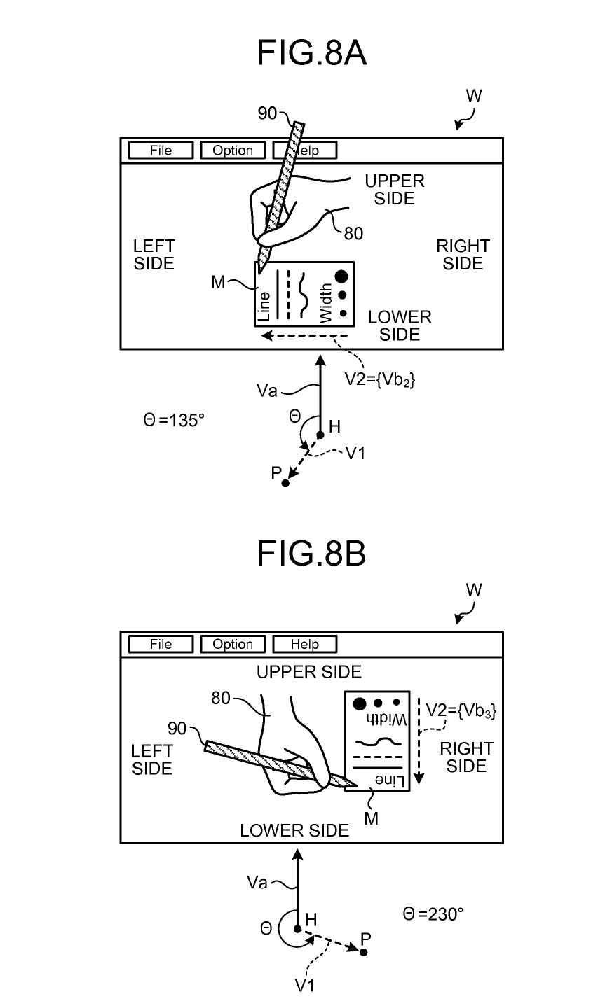

FIGS. 8A and 8B are diagrams that illustrate examples of the operation performed at the time of performing display control according to this embodiment. FIGS. 8A and 8B illustrate examples of the operation of display control in a case where the hand 80 holding the pen 90 is the right hand (the user's dominant hand is the right hand). In the figures, in a case where the upward direction of the screen W is used as the reference, FIG. 8A illustrates Operation Example 1 in a case where the user is positioned to the “right side” of the screen, and FIG. 8B illustrates Operation Example 2 in a case where the user is positioned to the “upper side” of the screen.

### Operation Example 1

As illustrated in FIG. 8A, for example, as the user is positioned to the “right side” of the screen, the first vector calculator 13 is assumed to acquire an angle Θ, which is formed by the reference vector Va and the first vector V1, of 135°. In such a case, the second vector calculator 14 acquires an angle a=90° through calculation using Equation 1-1. In accordance with this, the second vector calculator 14 acquires difference values c₁ to c₄ {=90°, 0°, 90°, and 180°} between the angle a {=90°} and the angles b₁ to b₄ {=0°, 90°, 180°, and 270°} through calculation using Equations 2-1 to 2-4. The second vector calculator 14 specifies an angle b₂ {=90°} having a calculation result of the least difference value c from among the acquired difference values c₁ to c₄ {=90°, 0°, 90°, and 180°}. As a result, the second vector calculator 14 selects the candidate vector Vb₂ corresponding to the angle b₂ {=90°} from among a plurality of candidate vectors Vb. From this, the second vector calculator 14 sets the selected candidate vector Vb₂ as the second vector V2. The display control unit 15 rotates the image counterclockwise by 90° such that the display direction of the image of the operation menu M is the direction of the second vector V2 (selected candidate vector Vb₂) and displays the image after rotation near the pen 90.

### Operation Example 2

As illustrated in FIG. 8B, for example, as the user is positioned to the “upper side” of the screen, the first vector calculator 13 is assumed to acquire an angle Θ, which is formed by the reference vector Va and the first vector V1, of 230°. In such a case, the second vector calculator 14 acquires an angle a=185° through calculation using Equation 1-1. In accordance with this, the second vector calculator 14 acquires difference values c₁ to c₄ {=185°, 95°, 5°, and 85°} between the angle a {=185°} and the angles b₁ to b₄ {=0°, 90°, 180°, and 270°} through calculation using Equations (2-1) to (2-4). The second vector calculator 14 specifies an angle b₃ {=180°} having a calculation result of the least difference value c from among the acquired difference values c₁ to c₄ {=185°, 95°, 5°, and 85°}. As a result, the second vector calculator 14 selects the candidate vector Vb₃ corresponding to the angle b₃ {=180°} from among a plurality of candidate vectors Vb. From this, the second vector calculator 14 sets the selected candidate vector Vb₃ as the second vector V2. The display control unit 15 rotates the image counterclockwise by 180° such that the display direction of the image of the operation menu M is the direction of the second vector V2 (selected candidate vector Vb₃) and displays the image after rotation near the pen 90.

### SUMMARY

As above, according to the display control device 100 of this embodiment, the first position information acquiring unit 11 acquires the first position information (pen position information) of the screen W based on the contact position P of the pen 90. In addition, in the display control device 100 according to this embodiment, the second position information acquiring unit 12 acquires the second position information (hand position information) of the screen W based on the contact position H of the hand 80 holding the pen 90. In the display control device 100 according to this embodiment, the first vector calculator 13 calculates the first vector V1 having the contact position H of the hand 80 holding the pen 90 as a start point and has the contact position P of the pen 90 as an end point based on the first position information and the second position information. At this time, the first vector calculator 13 acquires an angle Θ formed by the reference vector Va representing the upward direction of the screen W and the first vector V1. In the display control device 100 according to this embodiment, the second vector calculator 14 estimates the user's direction with respect to the screen W based on the angle Θ formed by the reference vector Va and the calculated first vector V1. The second vector calculator 14 calculates the second vector V2 that represents the display direction of the image of the operation menu M corresponding to the control target image based on the result of the estimation. At this time, the second vector calculator 14 estimates the user's direction of a case where the upward direction of the screen W is used as the reference based on the angle Θ formed by the reference vector Va and the first vector V1. As a result, the second vector calculator 14 selects one vector representing the display direction for the estimated user's direction from among a plurality of candidate vectors Vb representing user's direction considered for the screen W. From this, the second vector calculator 14 sets the selected vector as the second vector V2, thereby calculating the second vector V2 that represents the display direction according to the user's direction. In the display control device 100 according to this embodiment, the display control unit 15 controls the display by rotating the image of the operation menu M in accordance with the calculated second vector V2. At this time, the display control unit 15 rotates the image counterclockwise such that the display direction of the image of the operation menu M is the direction of the second vector V2 and displays the image after rotation near the pen 90.

From this, the display control device 100 according to this embodiment provides an environment in which the user's direction for the screen W is estimated based on two units of the position information of the pen 90 and the hand 80 holding the pen 90, and the image is rotated and displayed in accordance with the estimated user's direction.

As a result, the display control device 100 according to this embodiment can change the direction of the display image so as to be an appropriate reading direction in accordance with the user's direction for the screen W. From this, the display control device 100 according to this embodiment can display the screen in an appropriate reading direction for the user on the use situation of reading information and operating screen in a plurality of directions even in the case of a display form having a specified reading direction. Accordingly, the display control device 100 according to this embodiment can provide a reading and operating environment having a high degree of convenience.

In the above-described embodiment, although an example of a case where the display directions to which the screen W can respond are four directions of the upward, downward, leftward, and rightward directions according to the rectangle of the screen W has been described, the display direction is not limited thereto. For example, in a case where the screen W has a circular shape, a polygon shape, or the like, the number of display directions to which the screen W can respond may be a number (division number) acquired by dividing 360° into a predetermined number. For example, in a case where the screen W has a hexagon shape, six directions corresponding to the sides of the hexagon may be set as the display directions to which the screen W can respond. In such a case, the number of selection candidates (the number of candidate vectors) for the second vector V2 is six, and angles b₁ to b₆ formed by the reference vector Va and the candidate vectors Vb₁ to Vb₆ are {0°, 60°, 120°, 180°, 240°, and 300°}. In such a case, the pen 90 relines counterclockwise at an angle of 45° with the vector in the direction perpendicular to each side of the screen W of the hexagon used as the reference. Accordingly, the second adjustment amount β represented in Equation 1 is a difference value between 45° and 30°, which is 15°. In this way, the number of selection candidates for the second vector V2 (Equation 1) and the second adjustment amount β may be set in accordance with the number of display directions to be responded based on the shape of the screen W.

In addition, in the above-described embodiment, an example of a case has been described in which, by touching an arbitrary position on the screen W for a predetermined time using the pen 90 (long press), the image of the operation menu M corresponding to the control target image is displayed, however, the operation is not limited thereto. The display of the operation menu M may be triggered, for example, by tapping on an arbitrary position on the image W with the pen 90 or pressing a button (hardware switch) included in the pen 90.

Furthermore, in the above-described embodiment, although an example of a case has been described in which the first vector V1 is calculated based on two units of position information of the pen 90 and the hand 80 holding the pen 90, the calculation method is not limited thereto. For example, in a case where the pen 90 can detect the inclination in the three-dimensional space, the first vector V1 may be calculated based on a detection result (inclination information) of the inclination. In such a case, the estimation unit 10 has a configuration that includes a functional unit acquiring a detection result of the inclination of the pen 90 in the three-dimensional space instead of the first position information acquiring unit 11 and the second position information acquiring unit 12. In addition, on the premise that a touch area (contact area) of the hand 80 holding the pen 90 is present on the screen W, although an example of a case has been described in which the image of the operation menu M corresponding to the control target image is displayed, in a case where a touch area is not detectable, the image may be displayed in a predetermined reference direction (for example, the direction of the reference vector Va) or the direction in which the operation menu has been previously displayed.

In addition, in this embodiment, while an example of a case has been described in which the image of the operation menu M is set as the control target image, the control target image is not limited thereto. For example, the control target image may be a memo image of a tag function or the like. In other words, the control target image may be an image for which the user independently performs information reading and the screen operation. Furthermore, for an image shared on the screen W, it is considered that the information reading and the screen operation are performed by a plurality of users, and accordingly, the display direction may not be controlled for a specific user.

Modification 1

In the above-described embodiment, although an example of a case has been described in which the hand 80 holding the pen 90 is the right hand (the user's dominant hand is the right hand), the hand is not limited thereto. In this Modification 1, a case will be described in which the hand 80 holding the pen 90 is the left hand (the user's dominant hand is the left hand). Hereinafter, items different from those of the above-described embodiment will be described, the same reference numeral is assigned to the same unit, and description thereof will be simplified or will not be presented.

In a case where the hand 80 holding the pen 90 is the left hand, the set value of the first adjustment amount a represented in Equation 1 is different from that of the case of the right hand. In this Modification 1, it is assumed that the user's dominant hand is the left hand, there is no habit in the way of holding the pen 90. In such a case, the first adjustment amount α may be 90°. In this Modification 1, it is assumed that information reading and the screen operation are performed for the screen W in four directions of the upward, downward, leftward, and rightward directions. Accordingly, also in this Modification 1, the second adjustment amount β is set to 45°.

From this, in this Modification 1, Equation (1) becomes Equation (1-2).

a=Θ+45° (1-2)

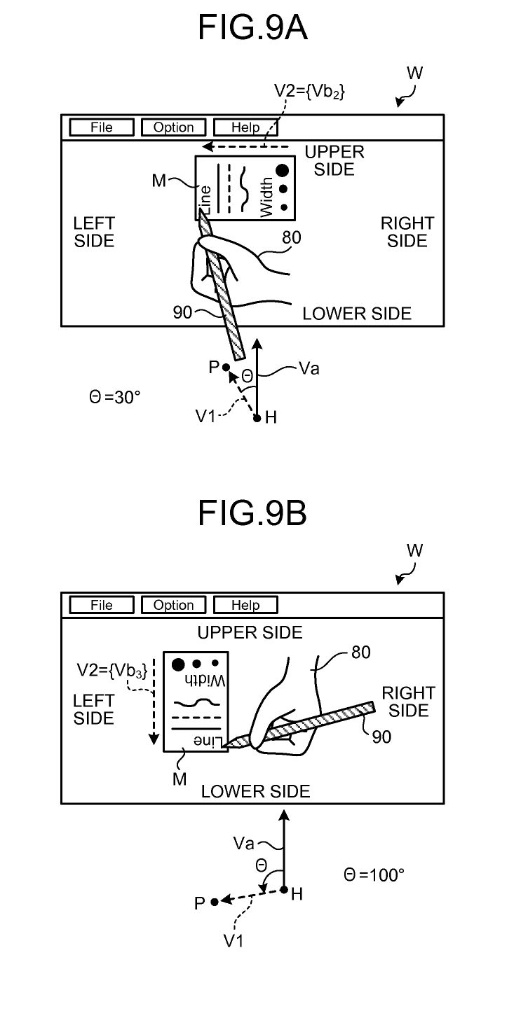

FIGS. 9A and 9B are diagrams that illustrate examples of the operation performed at the time of performing display control according to this Modification 1. FIGS. 9A and 9B illustrate examples of the operation of display control in a case where the hand 80 holding the pen 90 is the left hand. In the figures, in a case where the upward direction of the screen W is used as the reference, FIG. 9A illustrates Operation Example 1 in a case where the user is positioned to the “right side” of the screen, and FIG. 9B illustrates Operation Example 2 in a case where the user is positioned to the “upper side” of the screen.

### Operation Example 1

As illustrated in FIG. 9A, for example, as the user is positioned to the “right side” of the screen, the first vector calculator 13 is assumed to acquire an angle Θ, which is formed by the reference vector Va and the first vector V1, of 30°. In such a case, the second vector calculator 14 acquires an angle a=75° through calculation using Equation 1-2. In accordance with this, the second vector calculator 14 acquires difference values c₁ to c₄ {=75°, 15°, 105°, and 195° } between the angle a {=75°} and the angles b₁ to b₄ {=0°, 90°, 180°, and 270°} through calculation using Equations 2-1 to 2-4. The second vector calculator 14 specifies an angle b₂ {=90°} having a calculation result of the least difference value c from among the acquired difference values c₁ to c₄ {=75°, 15°, 105°, and 195°}. As a result, the second vector calculator 14 selects the candidate vector Vb₂ corresponding to the angle b₂ {=90°} from among a plurality of candidate vectors Vb. From this, the second vector calculator 14 sets the selected candidate vector Vb₂ as the second vector V2. The display control unit 15 rotates the image counterclockwise by 90° such that the display direction of the image of the operation menu M is the direction of the second vector V2 (selected candidate vector Vb₂) and displays the image after rotation near the pen 90.

### Operation Example 2

As illustrated in FIG. 9B, for example, as the user is positioned to the “upper side” of the screen, the first vector calculator 13 is assumed to acquire an angle Θ, which is formed by the reference vector Va and the first vector V1, of 100°. In such a case, the second vector calculator 14 acquires an angle a=145° through calculation using Equation 1-2. In accordance with this, the second vector calculator 14 acquires difference values c₁ to c₄ {=145°, 55°, 35°, and 125°} between the angle a {=145°} and the angles b₁ to b₄ {=0°, 90°, 180°, and 270°} through calculation using Equations 2-1 to 2-4. The second vector calculator 14 specifies an angle b₃ {=180°} having a calculation result of the least difference value c from among the acquired difference values c₁ to c₄ {=145°, 55°, 35°, and 125°}. As a result, the second vector calculator 14 selects the candidate vector Vb₃ corresponding to the angle b₃ {=180°} from among a plurality of candidate vectors Vb. From this, the second vector calculator 14 sets the selected candidate vector Vb₃ as the second vector V2. The display control unit 15 rotates the image counterclockwise by 180° such that the display direction of the image of the operation menu M is the direction of the second vector V2 (selected candidate vector Vb₃) and displays the image after rotation near the pen 90.

In addition, the display control unit 15 displays the image of the operation menu M at a position not hidden by the pen 90, the hand 80, or the like by displaying the image such that the coordinate value of the upper left end point of the image after rotation coincides with the coordinate value of the contact position P of the pen 90.

In this way, the display control device 100 according to this Modification 1 can change the direction of the display image so as to be an appropriate reading direction in accordance with the user's direction with respect to the screen W regardless of the hand 80 (user's dominant hand) holding the pen 90.

Modification 2

In the above-described embodiment, although an example of a case has been described in which there is no habit in the way of holding the pen 90, the embodiment is not limited thereto. In this Modification 2, a case will be described in which there is a habit in the way of holding the pen 90. Hereinafter, items different from those of the above-described embodiment will be described, the same reference numeral is assigned to the same unit, and description thereof will be simplified or will not be presented.

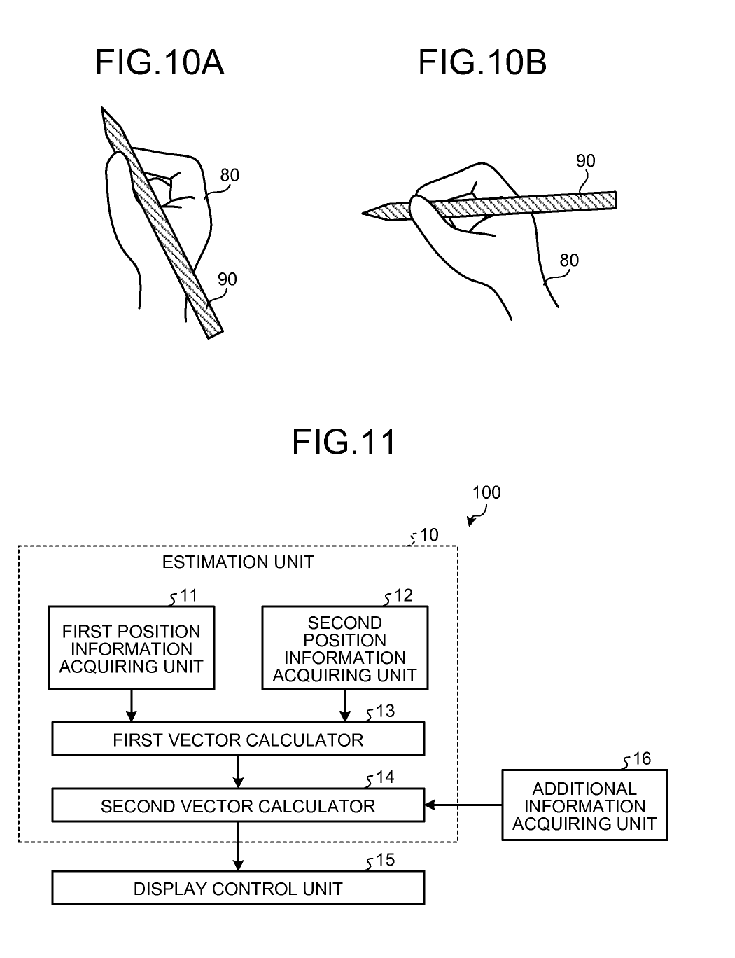

FIGS. 10A and 10B are diagrams that illustrate characteristics of ways of holding the pen 90 according to this Modification 2. FIGS. 10A and 10B illustrate characteristics of different ways of holding the pen 90 depending on each user. There are various ways of holding the pen 90 depending on persons. For example, the holding way illustrated in FIG. 10B has a characteristic of holding the pen 90 to be wound more than the holding way illustrated in FIG. 10A.

In a case where there is a habit in the way of holding the pen 90, a set value of the first adjustment amount a represented in Equation 1 is different from that of a case where there is no habit in the holding way. In this Modification 2, a case is assumed in which the user's dominant hand is the right hand and holds the pen 90 to be wound counterclockwise by 45°. In such a case, the first adjustment amount α is set to −45°. In other words, in a case where there is a habit in the way of holding the pen 90, the first adjustment amount a may be set so as to offset an extra angle (an angle of 45° corresponding to the winding) occurring due to the habit in the calculation using Equation 1. In this Modification 2, angle adjustment (angle adjustment in consideration of the characteristic of the way of holding) can be performed based on the way of holding the pen 90 by using such a method.

In this way, according to the display control device 100 of this Modification 2, the direction of the display image can be changed to be an appropriate reading direction in accordance with the user's direction with respect to the screen W regardless of the way of holding the pen 90.

### Second Embodiment

### Overview

In the above-described embodiment, a case has been described in which one of the right hand and the left hand is assumed as the hand (user's dominant hand) holding the pen. However, when various use situations are considered, it cannot be determined that the device is necessarily used by users having the same dominant hands. Thus, in this embodiment, a display control device is proposed which estimates the user's direction with respect to the screen based on the user's dominant hand, and the image is rotated and displayed in accordance with the estimated user's direction.

From this, the display control device according to this embodiment can change the direction of the display image to be an appropriate reading direction in accordance with the user's direction with respect to the screen even in the case of being used by a plurality of users having different dominant hands. From this, the display control device according to this embodiment can display the screen in a direction that is appropriate for a user even in the case of a display form having a specified reading direction on the use situations of reading information and operating screen performed by a plurality of users in a plurality of directions. Accordingly, the display control device according to this embodiment can provide a reading/operating environment having a high degree of convenience.

Hereinafter, the configuration and the operation of the display control function according to this embodiment will be described. Hereinafter, items different from those of the above-described embodiment will be described, the same reference numeral is assigned to the same unit, and description thereof will be simplified or will not be presented.

Functional Configuration

FIG. 11 is a diagram that illustrates an example of the functional configuration of the display control device 100 according to this embodiment. As illustrated in FIG. 11, the display control device 100 according to this embodiment further includes an additional information acquiring unit 16.

The additional information acquiring unit 16 acquires additional information relating to the dominant hand of a user. The additional information includes, for example, information used for identifying the hand 80 holding the pen 90, in other words, information (hereinafter, referred to as “dominant hand information”) representing the user's dominant hand, information (hereinafter, referred to as “control information”) used for calculating (selecting) the second vector V2 in accordance with the dominant hand, and the like. The additional information, for example, is maintained in a predetermined storage area of a storage device included in the display control device 100. Accordingly, the additional information acquiring unit 16 accesses the predetermined storage area in which the information is stored, thereby acquiring the additional information.

Here, the additional information according to this embodiment will be described.

Dominant Hand Information

In the dominant hand information according to this embodiment, in the use situations that are considered, an identifier used for identifying the dominant hand having a high use frequency is set in advance as a default value. Thereafter, on an actual use situation, a user changes the set value in accordance with the dominant hand by using a predetermined user interface (UI) function. In this embodiment, by using such a method, the dominant hand of the user using the display control device 100 is recorded as the additional information. From this, the additional information acquiring unit 16 acquires the dominant hand information according to a user using the display control device 100.

Control Information

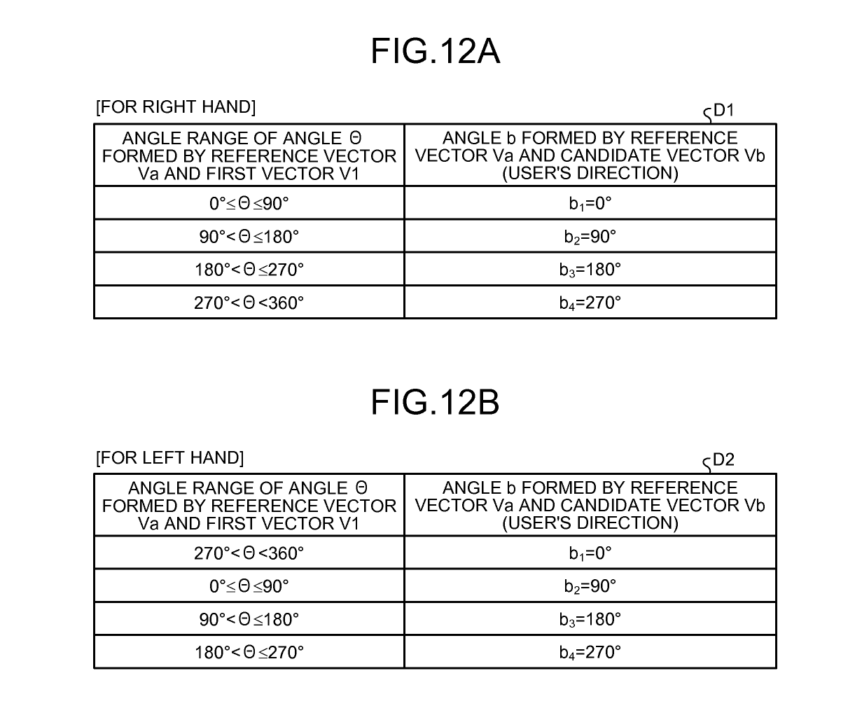

FIGS. 12A and 12B are diagrams that illustrate examples of data of control information D1 and D2 according to this embodiment. FIG. 12A represents an example of data of the control information (control information for the right hand) D1 of a case where the dominant hand is the right hand (right-handed), and FIG. 12B represents an example of data of the control information (control information for the left hand) D2 of a case where the dominant hand is the left hand (left-handed).

As illustrated in FIG. 12, in the control information D1 and D2 (hereinafter, referred to as “control information D” in the case of being collectively referred to) according to this embodiment, information items of angle information of the first vector V1 with respect to the reference vector Va and angle information of the candidate vector Vb are associated with each other.

In the angle information of the first vector V1, a plurality of predetermined ranges (hereinafter, referred to as “angle ranges”) of the value of the angle Θ formed by the reference vector Va and the first vector V1 are set. In the angle information of the candidate vector Vb, the values (the values of a plurality of angles b representing the user's directions considered for the screen W) of the angles b formed by the reference vector Va and a plurality of candidate vectors Vb are set. Such information items are associated with each other in units of the display directions to which the screen W can respond in accordance with the user's direction. In the examples of data illustrated in FIGS. 12A and 12B, the angle information of the first vector V1 and the angle information of the candidate vector Vb are set in association with each other for each one of the upward, downward, leftward, and rightward directions to which the screen W can respond. In other words, in the control information D according to this embodiment, a predetermined range of the direction of the first vector V1 calculated based on two units of position information of the pen 90 and the hand 80 holding the pen 90 and the user's upward, downward, leftward, and rightward directions (candidates of the display directions to which the screen W can respond) that are estimated at this time are set in association with each other.

The control information D according to this embodiment is set in advance in accordance with the dominant hands (the right hand and the left hand) considered on the use situation by using a predetermined UI function.

From this, the additional information acquiring unit 16 acquires two units of control information D1 and D2 of the right and left hands considered as the dominant hand of a user using the display control device 100.

The description will be continued with reference to FIG. 11. The second vector calculator 14 according to this embodiment specifies an angle b formed by the reference vector Va and the candidate vector Vb set in association with the angle range of the formed angle Θ based on the angle Θ formed by the reference vector Va and the first vector V1 by referring to the control information D. From this, the second vector calculator 14 estimates the user's direction of a case where the upward direction of the screen W is used as the reference.

In accordance with this, the second vector calculator 14 sets the candidate vector Vb corresponding to a specified angle b as the second vector V2, thereby calculating the second vector V2 that represents the display direction according to the user's direction.

More specifically, the second vector calculator 14 selects the second vector V2 using the following method. The second vector calculator 14, first, receives the dominant hand information and two units of control information D1 and D2 for the right hand and the left hand from the additional information acquiring unit 16 as the acquired additional information. In accordance with this, the second vector calculator 14 determines the dominant hand of the user based on the dominant hand information. The second vector calculator 14 refers to the control information D corresponding to the determined dominant hand based on the result of the determination of the dominant hand. For example, in a case where the dominant hand is the right hand, out of the two units of the control information D1 and D2, which have been received, the second vector calculator 14 refers to the control information D1 for the right hand. The second vector calculator 14 specifies an angle range corresponding to the angle Θ formed by the reference vector Va and the first vector V1 from among a plurality of set values of the angle range of the control information D that has been referred to. As a result, the second vector calculator 14 specifies an angle b formed by the reference vector Va and the candidate vector Vb that is set in association with the specified angle range. From this, the second vector calculator 14 selects one, which is a vector representing the user's direction, from among a plurality of the candidate vectors Vb based on the specified angle. The second vector calculator 14 acquires the selected vector as a result of the calculation of the second vector V2.

In this way, the second vector calculator 14 according to this embodiment changes the control information D used in a case where the second vector V2 is selected in accordance with the user's dominant hand. In addition, the second vector calculator 14 determines a display direction that is appropriate for the estimated user's direction out of a plurality of directions corresponding to the candidates for the display direction that are set in the control information D in association with the angle Θ formed by the reference vector Va and the first vector V1. The second vector calculator 14 sets the determined direction as the direction of the second vector V2.

Details

Hereinafter, a detailed operation (associated operations of the functional units) of the display control device 100 according to this embodiment will be described with reference to a flowchart.

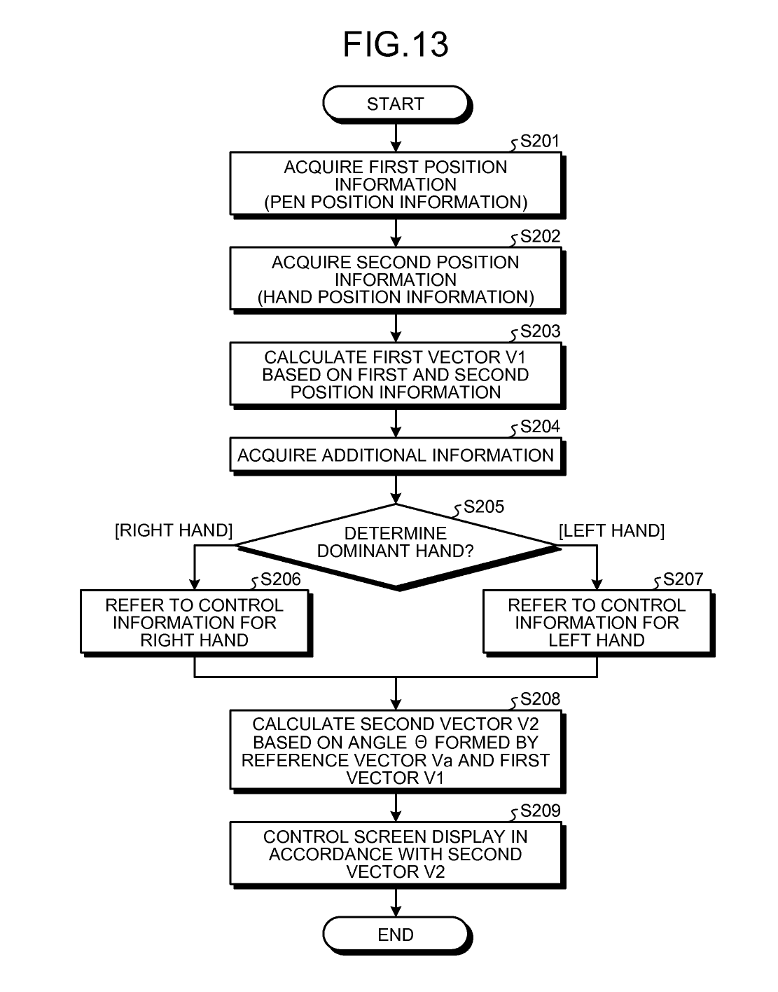

FIG. 13 is a flowchart that illustrates an example of the process sequence at the time of performing display control according to this embodiment. As illustrated in FIG. 13, in the display control device 100 according to this embodiment, first, the first position information acquiring unit 11 acquires the first position information (pen position information) based on the contact position P of the pen 90 in Step S201. Next, in the display control device 100, the second position information acquiring unit 12 acquires the second position information (hand position information) based on the contact position H of the hand 80 holding the pen 90 in Step S202.

In accordance with this, in the display control device 100, the first vector calculator 13 calculates the first vector V1 based on the first position information (pen position information) and the second position information (hand position information) that have been acquired, in Step S203. At this time, the first vector calculator 13 calculates the first vector V1 having the contact position H of the hand 80, which is based on the second position information, as a start point and has the contact position P of the pen 90, which is based on the first position information, as an end point and acquires an angle Θ formed by the reference vector Va representing the upward direction of the screen W and the first vector V1.

Next, in the display control device 100, the additional information acquiring unit 16 acquires the additional information maintained in a predetermined storage area in Step S204. At this time, the additional information acquiring unit 16 acquires the dominant hand information of a user using the display control device 100 and two units of the control information D1 and D2 for the right hand and the left hand as the additional information and transfers the acquired additional information to the second vector calculator 14.

In accordance with this, in the display control device 100, the second vector calculator 14 determines the dominant hand of the user based on the dominant hand information in Step S205. As a result, in a case where the display control device 100 determines the dominant hand of the user to be the right hand (right hand in Step S205), the second vector calculator 14 refers to the control information D1 for the right hand in Step S206. On the other hand, in a case where the display control device 100 determines the dominant hand of the user to be the left hand (left hand in Step S205), the second vector calculator 14 refers to the control information D2 for the left hand in Step S207.

Next, the display control device 100 calculates the second vector V2 representing the display direction of the control target image based on the acquired angle Θ in Step S208. At this time, the second vector calculator 14 specifies the angle range corresponding to the angle Θ formed by the reference vector Va and the first vector V1 from among a plurality of set values of the angle range of the control information D and estimates the user's direction of a case where the upward direction of the screen W is used as the reference from the specified angle range. As a result, the second vector calculator 14 selects one vector representing the display direction for the estimated user's direction from among a plurality of candidate vectors Vb. From this, the second vector calculator 14 sets the selected vector as the second vector V2, thereby calculating the second vector V2 that represents the display direction according to the user's direction.

In accordance with this, in the display control device 100, the display control unit 15 controls the display in accordance with the calculated second vector V2 in Step S209. At this time, the display control unit 15 performs control of the rotation of the image in the coordinate space of the screen W such that the display direction of the image of the operation menu M corresponding to the control target image is the direction of the second vector V2.

Hereinafter, examples of the display control operation will be described using an example of specific numerical values. In the description presented below, the control information D illustrated in FIGS. 12A and 12B is used.

(A) In Case where User's Dominant Hand is Right Hand

### Operation Example 1

For example, as the user is positioned to the “right side” of the screen, the first vector calculator 13 is assumed to acquire an angle Θ, which is formed by the reference vector Va and the first vector V1, of 135°. In such a case, the second vector calculator 14 specifies an angle range {90°<Θ≦180°} corresponding to the angle Θ {=135°} formed by the reference vector Va and the first vector V1 by referring to the control information D1 for the right hand illustrated in FIG. 12A. In accordance with this, the second vector calculator 14 specifies an angle b2 {=90°} that is set in association with the specified angle range {90°<Θ≦180°}. As a result, the second vector calculator 14 selects the candidate vector Vb₂ corresponding to the angle b2 {=90°} from among a plurality of candidate vectors Vb. From this, the second vector calculator 14 sets the selected candidate vector Vb₂ as the second vector V2. The display control unit 15 rotates the image counterclockwise by 90° such that the display direction of the image of the operation menu M is the direction of the second vector V2 (selected candidate vector Vb₂) and displays the image after rotation near the pen 90.

### Operation Example 2

For example, as the user is positioned to the “upper side” of the screen, the first vector calculator 13 is assumed to acquire an angle Θ, which is formed by the reference vector Va and the first vector V1, of 230°. In such a case, the second vector calculator 14 specifies an angle range {180°<Θ≦270°} corresponding to the angle Θ {=230°} formed by the reference vector Va and the first vector V1 by referring to the control information D1 for the right hand illustrated in FIG. 12A. In accordance with this, the second vector calculator 14 specifies an angle b3 {=180°} that is set in association with the specified angle range {180°<Θ≦270°}. As a result, the second vector calculator 14 selects the candidate vector Vb₃ corresponding to the angle b₃ {=180°} from among a plurality of candidate vectors Vb. From this, the second vector calculator 14 sets the selected candidate vector Vb₃ as the second vector V2. The display control unit 15 rotates the image counterclockwise by 180° such that the display direction of the image of the operation menu M is the direction of the second vector V2 (selected candidate vector Vb₃) and displays the image after rotation near the pen 90.

(B) in Case where User's Dominant Hand is Left Hand Operation Example 1
For example, as the user is positioned to the “right side” of the screen, the first vector calculator 13 is assumed to acquire an angle Θ, which is formed by the reference vector Va and the first vector V1, of 30°. In such a case, the second vector calculator 14 specifies an angle range {0°<Θ≦90°} corresponding to the angle Θ {=30°} formed by the reference vector Va and the first vector V1 by referring to the control information D2 for the left hand illustrated in FIG. 12B. In accordance with this, the second vector calculator 14 specifies an angle b2 {=90°} that is set in association with the specified angle range {0°<Θ≦90°}. As a result, the second vector calculator 14 selects the candidate vector Vb₂ corresponding to the angle b2 {=90°} from among a plurality of candidate vectors Vb. From this, the second vector calculator 14 sets the selected candidate vector Vb₂ as the second vector V2. The display control unit 15 rotates the image counterclockwise by 90° such that the display direction of the image of the operation menu M is the direction of the second vector V2 (selected candidate vector Vb2) and displays the image after rotation near the pen 90.

### Operation Example 2

For example, as the user is positioned to the “upper side” of the screen, the first vector calculator 13 is assumed to acquire an angle Θ, which is formed by the reference vector Va and the first vector V1, of 100°. In such a case, the second vector calculator 14 specifies an angle range {90°<Θ≦180°} corresponding to the angle Θ {=100°} formed by the reference vector Va and the first vector V1 by referring to the control information D2 for the left hand illustrated in FIG. 12B. In accordance with this, the second vector calculator 14 specifies an angle b₃ {=180°} that is set in association with the specified angle range {90°<Θ≦180°}. As a result, the second vector calculator 14 selects the candidate vector Vb₃ corresponding to the angle b3 {=180°} from among a plurality of candidate vectors Vb. From this, the second vector calculator 14 sets the selected candidate vector Vb₃ as the second vector V2. The display control unit 15 rotates the image counterclockwise by 180° such that the display direction of the image of the operation menu M is the direction of the second vector V2 (selected candidate vector Vb₃) and displays the image after rotation near the pen 90.

### SUMMARY

As above, according to the display control device 100 of this embodiment, the first position information acquiring unit 11 acquires the first position information (pen position information) of the screen W based on the contact position P of the pen 90. In addition, in the display control device 100 according to this embodiment, the second position information acquiring unit 12 acquires the second position information (hand position information) of the screen W based on the contact position H of the hand 80 holding the pen 90. In the display control device 100 according to this embodiment, the first vector calculator 13 calculates the first vector V1 having the contact position H of the hand 80 holding the pen 90 as a start point and has the contact position P of the pen 90 as an end point based on the first position information and the second position information. At this time, the first vector calculator 13 acquires an angle Θ formed by the reference vector Va representing the upward direction of the screen W and the first vector V1. In the display control device 100 according to this embodiment, the additional information acquiring unit 16 acquires the control information D user for selecting the second vector V2 in accordance with the user's dominant hand information and the dominant hand as the additional information. In the display control device 100 according to this embodiment, the second vector calculator 14 estimates the user's direction with respect to the screen W based on the angle Θ formed by the reference vector Va and the calculated first vector V1. The second vector calculator 14 calculates the second vector V2 that represents the display direction of the image of the operation menu M corresponding to the control target image based on the result of the estimation. At this time, the second vector calculator 14 determines the user's dominant hand based on the dominant hand information and refers to the control information D corresponding to the determined dominant hand. Next, the second vector calculator 14 specifies an angle range corresponding to the angle Θ formed by the reference vector Va and the first vector V1 from among a plurality of angle ranges of the control information D. The second vector calculator 14 estimates the user's direction of a case where the upward direction of the screen W is used as the reference by specifying the angle b formed by the reference vector Va and the candidate vector Vb that is set in association with the specified angle range. As a result, the second vector calculator 14 selects one vector representing the display direction for the estimated user's direction from among a plurality of candidate vectors Vb representing user's direction considered for the screen W. From this, the second vector calculator 14 sets the selected vector as the second vector V2, thereby calculating the second vector V2 that represents the display direction according to the user's direction. In the display control device 100 according to this embodiment, the display control unit 15 controls the display by rotating the image of the operation menu M in accordance with the calculated second vector V2. At this time, the display control unit 15 rotates the image counterclockwise such that the display direction of the image of the operation menu M is the direction of the second vector V2 and displays the image after rotation near the pen 90.

As a result, even in a case where the device is used by a plurality of users having different dominant hands, the display control device 100 according to this embodiment can change the direction of the display image so as to be an appropriate reading direction in accordance with the user's direction with respect to the screen W. From this, the display control device 100 according to this embodiment can display the screen W in an appropriate reading direction for the users in the use situations of reading information and operating screen in a plurality of directions by a plurality of users even in the case of a display form having a specified reading direction. Accordingly, the display control device 100 according to this embodiment can provide a reading and operating environment having a high degree of convenience.

In the above-described embodiment, although an example of a case has been described in which the display control device 100 maintains the additional information in a predetermined storage area, the storage thereof is not limited thereto. The additional information, for example, may be maintained in a predetermined storage area of a storage device included in the pen 90 or a recording medium that can be accessed from the outside, or the like. In such a case, the additional information acquiring unit 16 acquires the additional information by accessing the pen 90, the recording medium, or the like through a predetermined data transmission path. From this, new additional information can be easily provided, and the information can be efficiently managed.

In addition, in this embodiment, an example of a case has been described in which the dominant hand (the hand 80 holding the pen 90) of the user is determined based on the provided additional information, the determination is not limited thereto. For the determination of the dominant hand, for example, it may be determined whether the dominant hand is the right hand or the left hand based on the shape of the touch area R of the hand 80 holding the pen 90. In such a case, the second vector calculator 14 makes the determination based on the aspect ratio of the touch area R detected by the second position information acquiring unit 12. From this, the additional information may not include the dominant hand information, whereby the amount of the information can be reduced.

In addition, in this embodiment, an example of a case has been described in which the second vector V2 is calculated by switching between the control information D1 for the right hand and the control information D2 for the left hand in accordance with the determined dominant hand of the user. In this way, the method of calculating the second vector V2 in accordance with the dominant hand of the user may be applied also to the first embodiment. In such a case, the second vector calculator 14 may change the set value of the first adjustment amount α represented in the calculation equation (Equation 1) that is used in a case where the angle a is calculated in accordance with the determined dominant hand of the user. More specifically, the second vector calculator 14 calculates the angle with the first adjustment amount α represented in Equation 1 being set to 0° in a case where the dominant hand of the user is determined to be the right hand and being set to 90° in a case where the dominant hand of the user is determined to be the left hand.

Furthermore, in this embodiment, although an example of the additional information including the dominant hand information and the control information D has been described, the additional information is not limited thereto. For example, the additional information may include handwriting information. The handwriting information described here corresponds to information that represents the handwriting direction (stroke direction) of characters written on the screen W such as a direction from the left side to the right side or a direction from the upper side to the lower side. For example, in a case where Japanese, English, or the like is horizontally written, the handwriting direction is a direction from the left side to the right side and from the upper side to the lower side. In addition, in a case where Japanese is horizontally written, the handwriting direction is a direction from the upper side to the lower side and from the right side to the left side. By using the characteristics of the handwriting direction, the user's direction with respect to the screen W can be estimated. More specifically, for example, in a case where a plurality of units of the handwriting information representing the handwriting directions of past and present are provided as the additional information, the second vector calculator 14 specifies the user's direction by specifying a superior direction that represents the user's direction with respect to the screen W based on a histogram generated from the handwriting information. The additional information, for example, may include language information. The language information described here corresponds to information representing the language of characters to be displayed. The display control unit 15 may select an image corresponding to a language from among a plurality of control target images (the images of the operation menus M) prepared for languages based on the language information at the time of performing display control.

Modification 3

In the above-described embodiment, although an example of the control information D assuming a case in which there is no habit in the way of holding the pen 90 has been described, the embodiment is not limited thereto. In this Modification 3, control information D assuming that there is a habit in the way of holding the pen 90 will be described. Hereinafter, items different from those of the above-described embodiment will be described, the same reference numeral is assigned to the same item, and description thereof will be simplified or will not be presented.

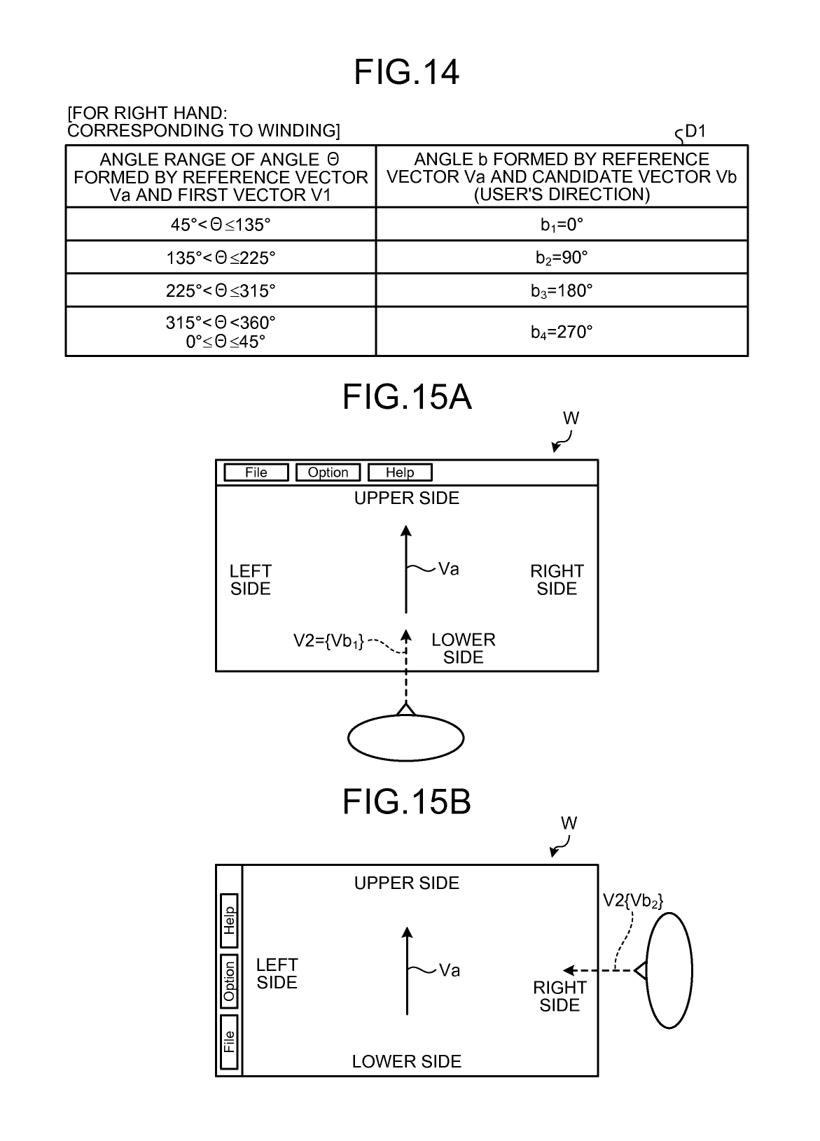

FIG. 14 is a diagram that illustrates an example of data of the control information D1 according to this Modification 3. FIG. 14 illustrates an example of data of the control information D1 so as to respond to a user having the right hand as the dominant hand (right-handed) and having a winding habit in the way of holding the pen 90.

A case where there is a habit in the way of holding the pen 90 is different from a case where there is no habit in the holding way included in a set value of the angle information (the angle range of the angle Θ formed by the reference vector Va and the first vector V1) of the first vector V1 included in the control information D. In this Modification 3, a case is assumed in which the user's dominant hand is the right hand and holds the pen 90 to be wound counterclockwise by 45°. In such a case, the angle range of the angle Θ formed by the reference vector Va and the first vector V1 is shifted by 45°. In other words, in a case where there is a habit in the way of holding the pen 90, an angle range acquired by taking an extra angle (the angle 45° corresponding to the winding) occurring due to the habit into account may be set. In this Modification 3, by using such a method, the angle adjustment can be performed based on the way of holding the pen 90.

In this way, according to the display control device 100 of this Modification 3, switching between the control information D1 for the right hand and the control information D2 for the left hand is performed in accordance with the dominant hand of a user. Even in a case where the second vector V2 is calculated using the control information D2, the display control device 100 according to this Modification 3 can change the direction of the display image in accordance with the user's direction with respect to the screen W so as to be an appropriate reading direction, regardless of the way of holding the pen 90.

Modification 4

In the above-described embodiment, although an example of a case has been described in which a part of the image displayed on the screen W, for example, such as the image of the operation menu M, is used as the control target image, the control target image is not limited thereto. In this Modification 4, display control for rotating the entire screen W will be described. Hereinafter, items different from those of the above-described embodiment will be described, the same reference numeral is assigned to the same unit, and description thereof will be simplified or will not be presented.

FIGS. 15A and 15B are diagrams that illustrate examples of the control of the screen W according to Modification 4. FIG. 15A illustrates an example of a case where a user is positioned below the screen W, and the display direction of the entire screen W is controlled so as to be the direction of the second vector V2 (selected candidate vector Vb₁). FIG. 15B illustrates an example of a case where a user is positioned to the right side of the screen W, and the display direction of the entire screen W is controlled so as to be the direction of the second vector V2 (selected candidate vector Vb₂).

In a case where the entire screen W is controlled, the display control unit 15 controls the rotation of the entire screen W in accordance with the second vector V2.

In this way, according to the display control device 100 of this Modification 4, the direction of the display image of the entire screen W can be changed to be an appropriate reading direction in accordance with the user's direction with respect to the screen W. This function is effective in the following case.

Among display control devices 100, there is a device which controls the rotation of the display direction of the entire screen W based on a detection result of an acceleration sensor. However, even in such a display control device 100, for example, in a case where the device is placed flat on a table or the like, a detection result of the acceleration sensor is not acquired, and the rotation of the display direction cannot be controlled. In addition, in a table-type display control device 100, there are many cases where an acceleration sensor is not included, and the rotation of the display direction cannot be controlled. In contrast to this, the display control device 100 according to this Modification 4 can control the rotation of the display direction of the entire screen W based on a result of the estimation of the user's direction with respect to the screen W even in a case where a detection result of the acceleration sensor cannot be acquired or a case where an acceleration sensor is not included.

Application Example of Method of Estimating User's Direction

Hereinafter, application examples of the method of estimating the user's direction with respect to the screen W, which has been described in the above-described embodiment, will be described. In the description presented below, the same reference numeral is assigned to the same item as that of the above-described embodiment.

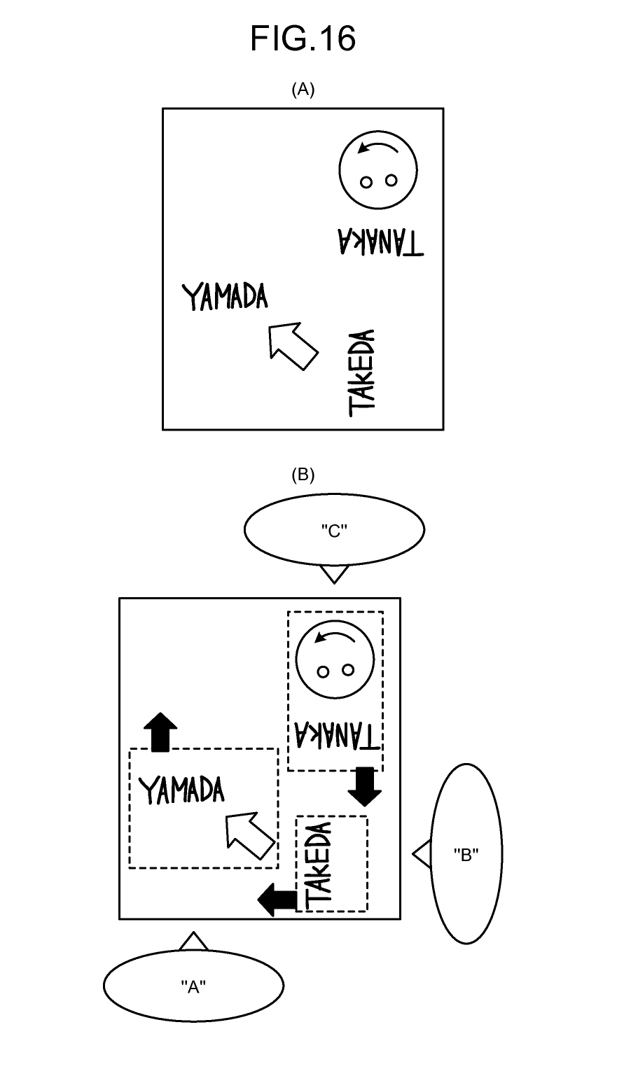

FIG. 16 illustrates an application examples of the estimation method according the above-described embodiment. FIG. 16 illustrates an example in which the method of estimating the user's direction with respect to the screen W is applied to the recognition of written characters and a drawn diagram on the screen W.

As illustrated in (A) of FIG. 16, on the screen W, there are cases where characters are written and a diagram is drawn, for example, by a plurality of users. In order to recognize the characters and the diagram for each user, generally, the handwriting direction of each user is used. However, in a case where the handwriting direction cannot be acquired due to some reasons, in order to recognize the characters and the diagram, the vertical directions of the characters and the diagram to be recognized may be required.

Thus, in this application example, the handwriting direction is not used, but the estimation method described in the above-described embodiment is used for a situation for recognizing the characters and the diagram. More specifically, as illustrated in (B) of FIG. 16, first, the display control device 100 calculates a first vector V1 and a second vector V2 and estimates positions “A”, “B”, and “C” of three users with respect to the screen W. Next, the display control device 100 specifies the vertical directions of the characters and the diagram (characters and diagrams that are written or drawn by the users) seen from each user of the positions “A”, “B”, and “C” based on the result of the estimation. As a result, the display control device 100 recognizes the characters and the diagram for each user based on the specified vertical direction.

In this way, the estimation method according to the above-described embodiment may be applied to the recognition of characters and diagrams and can acquire a result of the recognition even in a case where the handwriting direction cannot be acquired.

Example of Use Situation of Display Control Device 100

Here, examples of the use situation of the display control device 100 according to the above-described embodiment will be described. In the description presented below, the same reference numeral is assigned to the same item as that of the above-described embodiment.

Use Situation 1

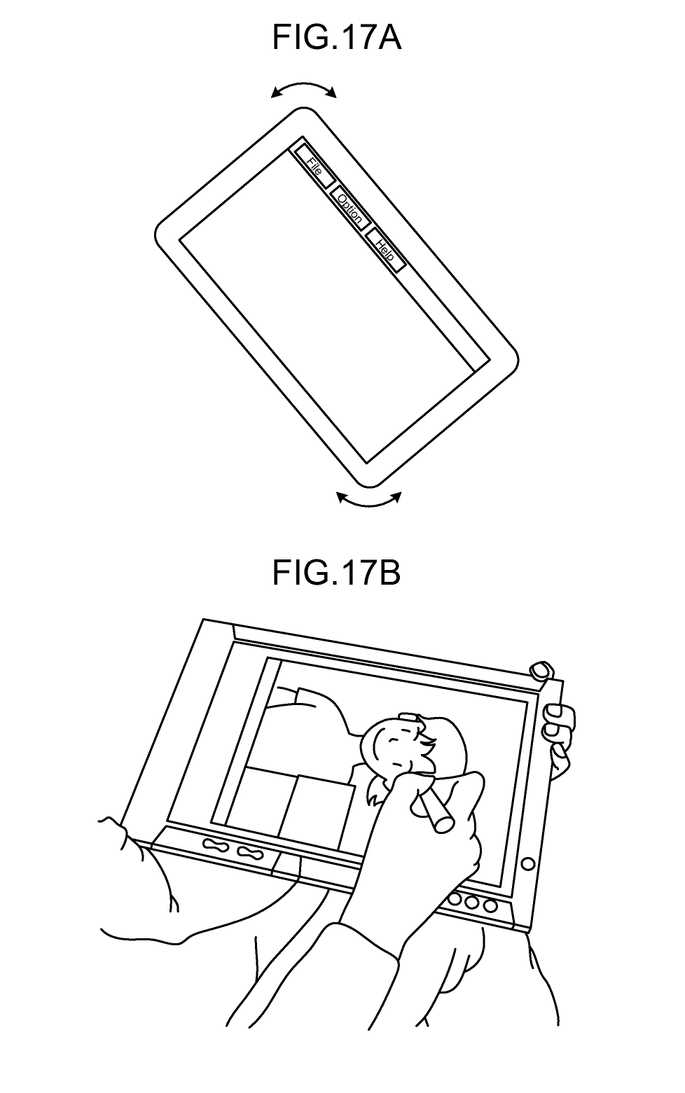

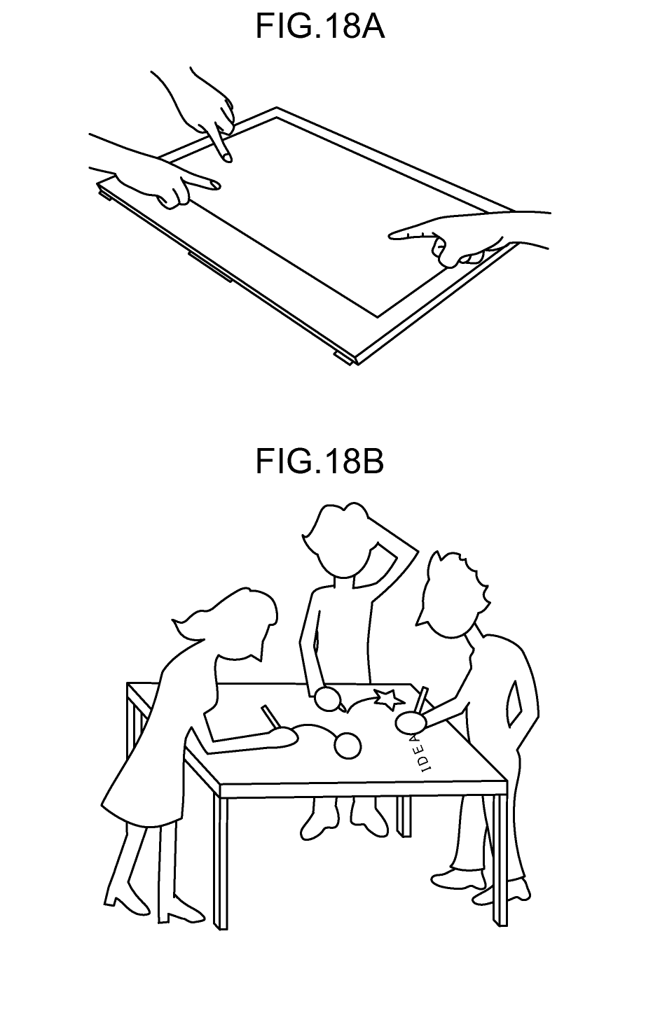

FIGS. 17A and 17B are diagrams that illustrate an example (1) of the use of the display control device 100 according to the above-described embodiment. As illustrated in FIG. 17A, a situation is assumed in which the display control device 100 according to the above-described embodiment is used while being rotated by a user. For example, as illustrated in FIG. 17B, this is a use situation that is assumed in a case where a picture is drawn on the screen W of the display control device 100 that is placed flat.

Even for a situation in which the device is rotated, the display control device 100 according to the above-described embodiment can change the direction of the display image so as to be an appropriate reading direction in accordance with the direction of the user with respect to the screen W and can provide a reading and operating environment having a high degree of convenience.

Use Situation 2

FIGS. 18A and 18B are diagrams that illustrate another example (2) of the use of the display control device 100 according to the above-described embodiment. As illustrated in FIGS. 18A and 18B, a situation is assumed on which the display control device 100 according to the above-described embodiment is used by a plurality of users in a plurality of directions. For example, this is a use situation assumed in a case where a plurality of persons are called and a meeting is held.

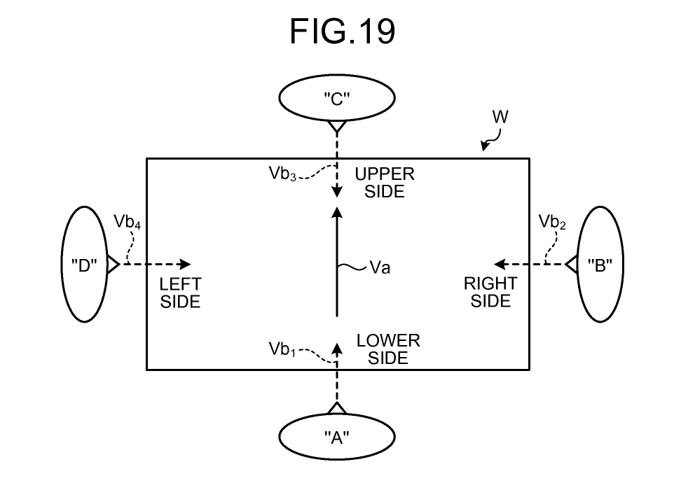

FIG. 19 is a diagram that illustrates an example of candidate vectors Vb₁ to Vb₄ in a case where the screen W is surrounded to be used by four users. For example, in a case where a user is positioned to the “lower side” of the screen as “A”, the user's direction watching the screen W (the user's direction) is the upward direction. Accordingly, a candidate vector Vb₁ representing the upward direction corresponds to the user's direction positioned to the “lower side” of the screen and corresponds to a display direction that is appropriate for the user. In addition, in a case where a user is positioned to the “right side” of the screen as “B”, the user's direction watching the screen W is the leftward direction. Accordingly, a candidate vector Vb₂ representing the leftward direction corresponds to the user's direction positioned to the “right side” of the screen and corresponds to a display direction that is appropriate for the user. Furthermore, in a case where a user is positioned to the “upper side” of the screen as “C”, the user's direction watching the screen W is the downward direction. Accordingly, a candidate vector Vb₃ representing the downward direction corresponds to the user's direction positioned to the “upper side” of the screen and corresponds to a display direction that is appropriate for the user. In addition, in a case where a user is positioned to the “left side” of the screen as “D”, the user's direction watching the screen W is the rightward direction. Accordingly, a candidate vector Vb₄ representing the rightward direction corresponds to the user's direction positioned to the “left side” of the screen and corresponds to a display direction that is appropriate for the user.

In this way, the display control device 100 according to the above-described embodiment can control the display by using the same method as that of a case where the device is used by one user in the upward, downward, leftward, and rightward directions of the screen W even for a situation on which the device is used by four users in the upward, downward, leftward, and rightward directions of the screen W.

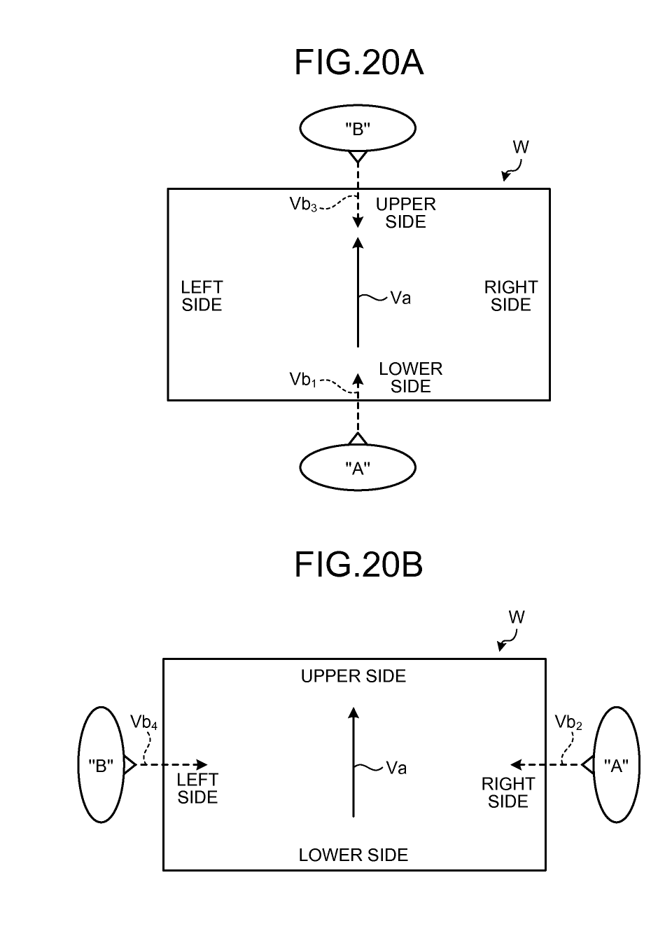

FIGS. 20A and 20B are diagrams that illustrate examples of candidate vectors Vb₁ to Vb₄ in a case where two users use the screen being interposed therebetween. FIG. 20A illustrates an example of a case in which two users are respectively positioned to the upper and lower sides of the screen W (a case where users vertically face each other). For example, in a case where a user is positioned to the “lower side” of the screen as “A”, the user's direction watching the screen W (the user's direction) is the upward direction. Accordingly, a candidate vector Vb₁ representing the upward direction corresponds to the user's direction positioned to the “lower side” of the screen and corresponds to a display direction that is appropriate for the user. In addition, in a case where a user is positioned to the “upper side” of the screen W as “B”, the user's direction watching the screen W is the downward direction. Accordingly, a candidate vector Vb₃ representing the downward direction corresponds to the user's direction positioned to the “upper side” of the screen and corresponds to a display direction that is appropriate for the user. FIG. 20B illustrates an example of a case in which two users are respectively positioned to the left and right sides of the screen W (a case where users horizontally face each other). For example, in a case where a user is positioned to the “right side” of the screen as “A”, the user's direction watching the screen W is the leftward direction. Accordingly, a candidate vector Vb₂ representing the leftward direction corresponds to the user's direction positioned to the “right side” of the screen and corresponds to a display direction that is appropriate for the user. In addition, in a case where a user is positioned to the “left side” of the screen as “B”, the user's direction watching the screen W is the rightward direction. Accordingly, a candidate vector Vb₄ representing the rightward direction corresponds to the user's direction positioned to the “left side” of the screen and corresponds to a display direction that is appropriate for the user.

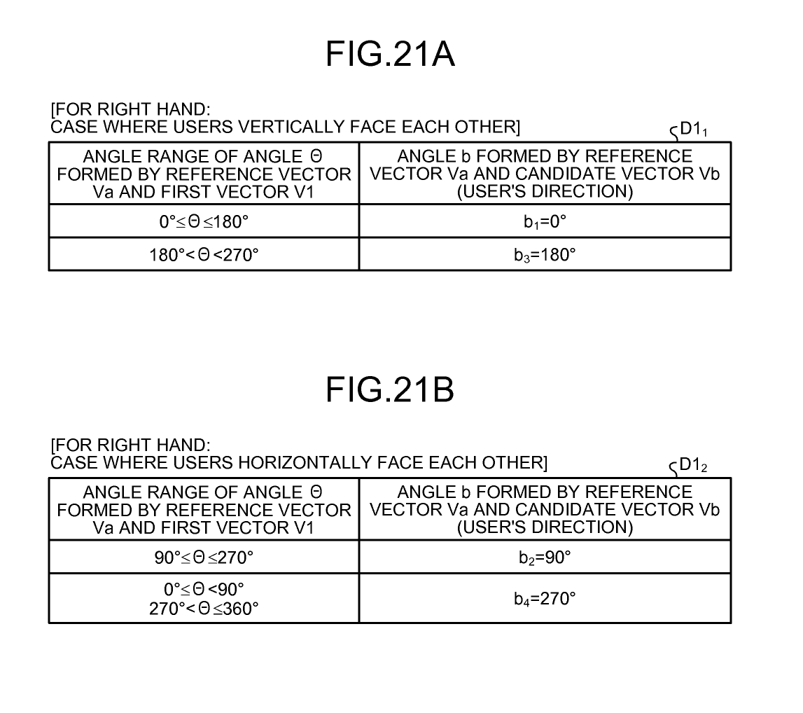

FIGS. 21A and 21B are diagrams that illustrates examples of data of control information D1₁ and D1₂ in a case where two users use the screen W being interposed therebetween. FIG. 21A illustrates an example of data of the control information D1₁ used in a case where two users are respectively positioned to the upper and lower sides of the screen W. In the example of the data illustrated in FIG. 21A, the angle information of the first vector V1 and the angle information of the second vector V2 are set in association with each other for each one of the upward and downward directions to which the screen W can respond. In other words, in the control information D according to this embodiment, a predetermined range of the direction of the first vector V1 calculated based on two units of position information of the pen 90 and the hand 80 holding the pen 90 and the user's upward and downward directions (candidates of the display directions to which the screen W can respond) that are estimated at this time are set in association with each other. FIG. 21B illustrates an example of data of the control information D1₂ used in a case where two users are respectively positioned to the left and right sides of the screen W. In the example of the data illustrated in FIG. 21B, the angle information of the first vector V1 and the angle information of the second vector V2 are set in association with each other for each one of the leftward and rightward directions to which the screen W can respond. In other words, in the control information D according to this embodiment, a predetermined range of the direction of the first vector V1 calculated based on two units of position information of the pen 90 and the hand 80 holding the pen 90 and the user's leftward and rightward directions that are estimated at this time are set in association with each other.

In this way, the display control device 100 according to the above-described embodiment can control the display by using the same method as that of a case where the device is used by one user in the upward, downward, leftward, and rightward directions of the screen W even for the situation on which the device is used by two users in the upward and downward directions or leftward and rightward directions of the screen W.

The display control device 100 according to the above-described embodiment can change the direction of the display image to be an appropriate direction in accordance with the user's direction with respect to the screen W even for the situation on which a plurality of users use the device in a plurality of directions and can provide reading and operating environments having a high degree of convenience.

Use Situation 3

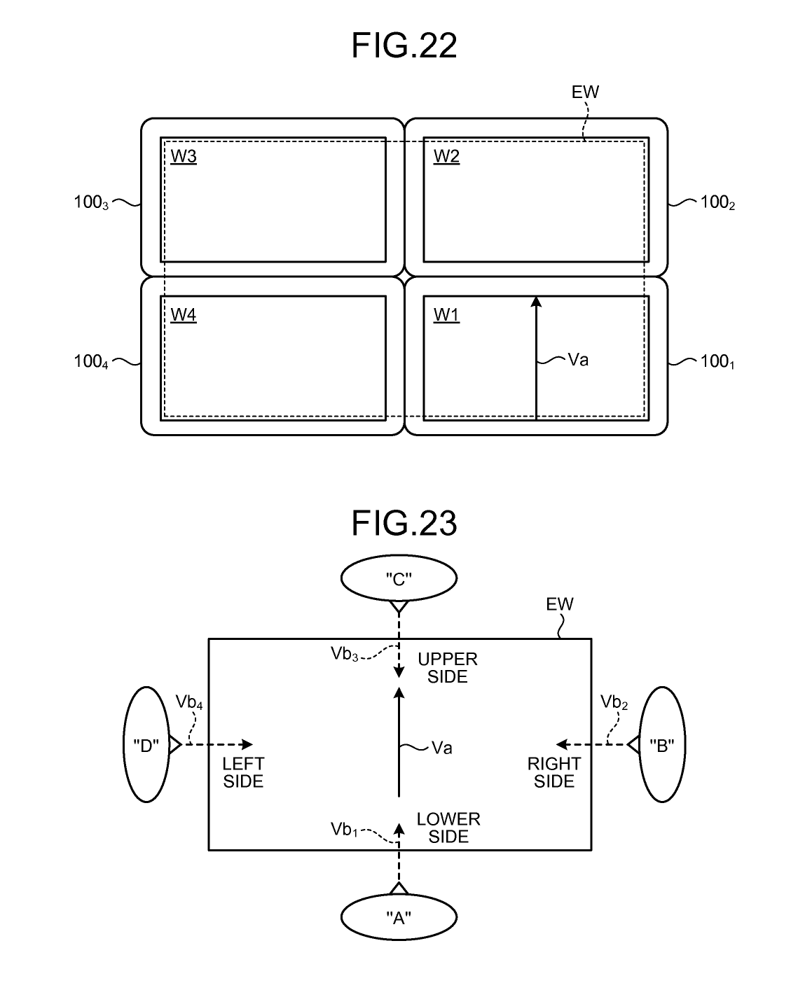

FIG. 22 is a diagram that illustrates an example of the use of a plurality of display control devices 100₁ to 100₄ according to the above-described embodiment. As illustrated in FIG. 22, in the display control device 100 according to the above-described embodiment, a situation is assumed on which a plurality of stands connected to each other through a predetermined data transmission path are used. This is a use situation that is assumed in a case where the screen W is desired to be used in an extended manner.

FIG. 22 illustrates a use example in which screens W1 to W4 are served as one screen (hereinafter, referred to as an “extended screen”) EW by connecting three display control devices 100₂ to 100₄ corresponding to extension units to a display control device 100₁ corresponding to a base unit and operating the display control devices in association with each other. In this case, the display control function described in the above-described embodiment is performed by the display control device 100₁ corresponding to the base unit. At this time, the display control device 100₁ acquires the first position information corresponding to the pen position information and the second position information corresponding to the hand position information from the three display control devices 100₂ to 100₄ corresponding to the extension units and calculates a first vector V1 based on the acquired two units of the position information. The display control device 100₁ estimates the user's direction with respect to the extended screen EW based on the angle Θ formed by the reference vector Va representing the upward direction of the extended screen EW and the calculated first vector V1. The display control device 100₁ selects one vector representing the display direction for the estimated user's direction from among a plurality of candidate vectors Vb and sets the selected vector as the second vector V2, thereby calculating the second vector V2 representing the display direction according to the user's direction. As a result, the display control device 100₁ performs control of the rotation of the image in the coordinate space of the extended screen EW such that the display direction of the control target image is the direction of the second vector V2. Accordingly, in the three display control devices 100₂ to 100₄ corresponding to the extension units, only the function (position information acquiring function) including the first position information acquiring unit 11 and the second position information acquiring unit 12 may be operated.

FIG. 23 is a diagram that illustrates an example of candidate vectors Vb₁ to Vb₄ in a case where the extended screen EW is surrounded to be used by four users. For example, in a case where a user is positioned to the “lower side” of the extended screen as “A”, the user's direction watching the extended screen EW (the user's direction) is the upward direction. Accordingly, a candidate vector Vb₁ representing the upward direction corresponds to the user's direction positioned to the “lower side” of the extended screen and corresponds to a display direction that is appropriate for the user. In addition, in a case where a user is positioned to the “right side” of the extended screen as “B”, the user's direction watching the extended screen EW is the leftward direction. Accordingly, a candidate vector Vb₂ representing the leftward direction corresponds to the user's direction positioned to the “right side” of the extended screen and corresponds to a display direction that is appropriate for the user. Furthermore, in a case where a user is positioned to the “upper side” of the extended screen as “C”, the user's direction watching the extended screen EW is the downward direction. Accordingly, a candidate vector Vb₃ representing the downward direction corresponds to the user's direction positioned to the “upper side” of the extended screen and corresponds to a display direction that is appropriate for the user. In addition, in a case where a user is positioned to the “left side” of the extended screen as “D”, the user's direction watching the extended screen EW is the rightward direction. Accordingly, a candidate vector Vb₄ representing the rightward direction corresponds to the user's direction positioned to the “left side” of the extended screen and corresponds to a display direction that is appropriate for the user.

In this way, even for a situation on which a plurality of stands are used, the display control device 100 according to the above-described embodiment can control the display by using the same method as that of a case where one display control device is used.

Even for a situation on which the extended screen EW that serves by connecting a plurality of the stands is used, the display control device 100 according to the above-described embodiment can change the direction of the display image to be an appropriate reading direction in accordance with the user's direction with respect to the extended screen EW. Accordingly, the display control device 100 according to the above-described embodiment can provide a reading and operating environment having a high degree of convenience.

Modification 5

In the above-described embodiment, although an example has been described in which character recognition and diagram recognition are performed, the application is not limited thereto. The detection direction of a microphone having directivity or the output direction of a speaker having directivity may be operated in accordance with the user's direction with respect to the screen W. For example, in a case where the display control device 100 has a microphone acquiring sounds, by estimating the direction of a user performing handwriting and directing the detection direction of the microphone to the estimated direction, the sound of only the user performing handwriting can be acquired. In addition, for example, in a case where handwriting is performed while a plurality of persons discuss a subject, the sound of the user can be easily classified from speech sounds of the plurality of persons. Furthermore, by estimating the direction of a user starting the operation menu and directing the output of the speaker having directivity to the estimated direction, a speech announcement of the operation method can be presented to the user while it is difficult for the other users to hear the speech announcement.

In this way, the display control device 100 according to this Modification 5 changes the directivity of a sound acquiring unit and the directivity of a sound output unit in accordance with the direction of a user. The display control device 100 according to this Modification 5 can change the directivity such that an appropriate sound acquiring direction and an appropriate sound output direction are set in accordance with the user's direction with respect to the screen W.

Device

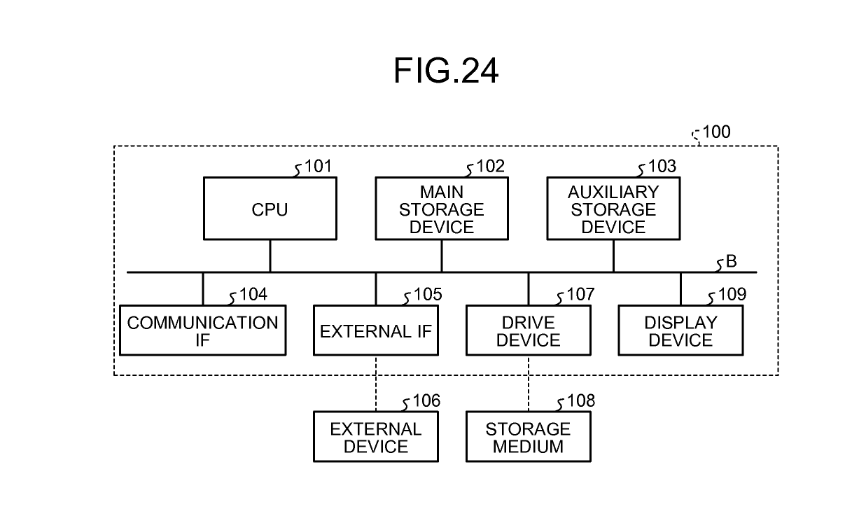

FIG. 24 is a diagram that illustrates an example of the configuration of the display control device 100 according to the above-described embodiment. As illustrated in FIG. 12, the display control device 100 according to an embodiment is equipped with a central processing unit (CPU) 101, a main storage device 102, and the like. In addition, the display control device 100 is equipped with an auxiliary storage device 103, a communication interface (IF) 104, an external IF 105, a drive device 107, a display device 109, and the like. In the display control device 100, such devices are interconnected through a bus B. In this way, the display control device 100 according to an embodiment corresponds to a general information processing apparatus.

The CPU 101 is an arithmetic unit used for realizing the control of the overall device and built-in functions. The main storage device 102 is a storage device (memory) that stores programs, data, and the like in a predetermined storage area. The main storage device 102, for example, is read only memory (ROM) or random access memory (RAM). The auxiliary storage device 103 is a storage device that includes a storage area having capacity larger than that of the main storage device 102. The auxiliary storage device 103, for example, is a non-volatile storage device such as a hard disk drive (HDD) or a memory card. Accordingly, the CPU 101, for example, reads a program or data from the auxiliary storage device 103 to the main storage device 102 and performs a process, thereby realizing control of the overall device or the built-in functions.

The communication IF 104 is an interface that connects the device to a data transmission path. From this, the display control device 100 can perform data communication with an external device (another display control device) connected through the data transmission path. The external IF 105 is an interface used for transmitting/receiving data between the device and external device 106. As the external device 106, for example, there is an input device (for example, a “numeric keypad” or a “keyboard”) receiving an operation input. The drive device 107 is a control device that writes data or reads data into/from a storage medium 108. The storage medium 108, for example, is a flexible disk (FD), a compact disk (CD), or a digital versatile disk (DVD). The display device 109, for example, is a display that displays various kinds of information such as a process result on the screen W. In addition, the display device 109 includes a sensor that detects a touch (contact) on the screen W. Accordingly, the display device 109 also serves as an input device that receives an operation input.

In addition, the display control function according to the above-described embodiment is realized, for example, by operating the above-described functional units in association with each other by executing a program in the display control device 100. In such a case, the program is provided by being recorded on a storage medium as a computer program product, from which data can be read by a device (computer) of the execution environment, as a file having an installable form or an executable form. For example, in the case of the display control device 100, the program has a modular configuration including the above-described functional units. The CPU 101 reads the program from the storage medium 108 and executes the program, whereby the functional units are generated in the RAM of the main storage device 102. However, the method of providing the program is not limited thereto. For example, a method may be used in which the program is stored in an external device connected to the internet or the like and is downloaded through a data transmission path. In addition, a method may be used in which the program is provided by being built in the ROM of the main storage device 102, the HDD of the auxiliary storage device 103, or the like, as a computer program product, in advance. Here, although an example has been described in which the display control function is realized by mounting software, the realization method is not limited thereto. For example, a part or the whole of the functional units included in the display control function may be realized by mounting hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display control device comprising:
a first acquisition unit configured to acquire first position information representing a first contact position on a screen with an input device;
a second acquisition unit configured to acquire second position information representing a second contact position on the screen with an object holding the input device;
a first calculator configured to calculate a first vector having the second contact position as a start point and having the first contact position as an end point based on the first position information and the second position information;
a second calculator configured to calculate a second vector representing a display direction based on an angle formed by a reference vector representing a first direction of the screen and the first vector; and
a controller configured to control the display in accordance with the second vector.

2. The device according to claim 1, wherein
the second calculator is configured to
estimate a direction of a user with respect to the screen based on the angle formed by the reference vector and the first vector, and
calculate the second vector that represents the display direction based on the estimated direction of the user.

3. The device according to claim 2, wherein
the second calculator is configured to
calculate a first angle by using an equation using the angle formed by the reference vector and the first vector and a first adjustment angle,
calculate a plurality of second angles that represent angles formed by the reference vector and respective candidate vectors representing potential directions of the user,
estimate the direction of the user by calculating difference values between the first angle and the plurality of second angles and specifying one of the plurality of second angles for which the difference value is the least,
select one of the candidate vectors that represents the display direction for the estimated direction of the user based on the specified second angle, and
set the selected candidate vector as the second vector.

4. The device according to claim 3, wherein
the second calculator is configured to calculate the first angle, in a case that the object holding the input device is a hand of the user, by using a first equation if the hand is the right hand and by using a second equation that is different from the first equation if the hand is the left hand.

5. The device according to claim 4, wherein the second calculator is configured to determine, in the case that the object holding the input device is the hand of the user, whether the hand is the right hand or the left hand based on additional information including dominant hand information that indicates whether a dominant hand of the user is the right hand or the left hand.

6. The device according to claim 4, wherein the second calculator is configured to determine, in the case that the object holding the input device is the hand of the user, whether the hand is the right hand or the left hand based on a result of analysis of a captured image of the hand holding the input device.

7. The device according to claim 3, wherein
the adjustment angle is based on a way of holding the input device, in a case where the object is a hand of the user.

8. The device according to claim 1, wherein
the second calculator is configured to
estimate the direction of the user with respect to the screen by using control information in which angle information of the first vector and angle information of candidate vectors are associated with each other, the angle information of the first vector comprising a plurality of angle ranges of the angle formed by the reference vector and the first vector, the angle information of the candidate vectors comprising a plurality of angles representing angles formed by the reference vector and respective candidate vectors representing the directions of the user assumed for the screen, and
calculate the second vector representing the display direction in accordance with the estimated direction of the user.

9. The device according to claim 8, wherein
the second calculator is configured to
estimate the direction of the user by specifying one of the plurality of angle ranges that corresponds to the angle formed by the reference vector and the first vector based on the angle formed by the reference vector and the first vector by referring to the angle information of the first vector and specifying one of the plurality of angles formed by the reference vector and the candidate vectors that is associated with the specified angle range by referring to the angle information of the candidate vectors,
select one of the candidate vectors that represents the display direction for the estimated direction of the user based on the specified angle, and
set the selected candidate vector as the second vector.

10. The device according to claim 9, wherein
the second calculator is configured to specify the angle range corresponding to the angle formed by the reference vector and the first vector based on the angle formed by the reference vector and the first vector, in a case that the object holding the input device is a hand of the user, by referring to the angle information of the first vector that is differently set for a case in which the hand holding the input device is the right hand and for a case in which the hand holding the input device is the left hand.

11. The device according to claim 10, wherein the second calculator is configured to determine, in the case that the object holding the input device is the hand of the user, whether the hand is the right hand or the left hand based on additional information including dominant hand information that indicates whether a dominant hand of the user is the right hand or the left hand.

12. The device according to claim 10, wherein the second calculator is configured to determine, in the case that the object holding the input device is the hand of the user, whether the hand is the right hand or the left hand based on a result of analysis of a captured image of the hand holding the input device.

13. The device according to claim 9, wherein
the second calculator is configured to specify the angle range corresponding to the angle formed by the reference vector and the first vector based on the angle formed by the reference vector and the first vector, in a case that the object holding the input device is a hand of the user, by referring to the angle information of the first vector having a set value that is based on a way of holding the input device.

14. The device according to claim 1, wherein the controller is configured to perform rotated display of a control target image or selective display of the control target image after rotation in accordance with the calculated second vector.

15. The device according to claim 14, wherein the controller is configured to set an image of the whole or a part of the screen as the control target image.

16. The device according to claim 1, wherein the first calculator is configured to calculate the first vector based on a result of detection of an inclination of the input device in a three-dimensional space.

17. The device according to claim 1, wherein
the second calculator is configured to
estimate the direction of the user with respect to the screen based on additional information including handwriting information that represents a direction of handwriting performed by the input device, and
calculate the second vector based on a result of the estimation.

18. A display control method comprising:
acquiring first position information representing a first contact position on a screen with an input device;
acquiring second position information representing a second contact position on the screen with an object holding the input device;
calculating a first vector having the second contact position as a start point and having the first contact position as an end point based on the first position information and the second position information;
calculating a second vector representing a display direction based on an angle formed by a reference vector representing a first direction of the screen and the first vector; and
controlling the display in accordance with the second vector.

19. A computer program product comprising a computer-readable medium containing a program executed by a computer, the program causing the computer to execute:
acquiring first position information representing a first contact position on a screen with an input device;
acquiring second position information representing a second contact position on the screen with an object holding the input device;
calculating a first vector having the second contact position as a start point and having the first contact position as an end point based on the first position information and the second position information;
calculating a second vector representing a display direction based on an angle formed by a reference vector representing a first direction of the screen and the first vector; and
controlling the display in accordance with the second vector.
